(19) United States
(12) Patent Application Publication
(10) Pub. No.: US 2007/0255633 A1
(43) Pub. Date: Nov. 1, 2007

(54) SYSTEMS AND METHODS FOR INVESTING

(76) Inventor: William J. Kridel, New York, NY (US)

Correspondence Address: PAUL, HASTINGS, JANOFSKY & WALKER LLP, P.O. BOX 919092, SAN DIEGO, CA, 92191-9092, US

(21) Appl. No.: 11/465,768

(22) Filed: Aug. 18, 2006

Related U.S. Application Data
(60) Provisional application No. 60/778,492, filed on Mar. 1, 2006.

(51) Int. Cl. G06Q 40/00

(52) U.S. Cl. 705/35

(57) ABSTRACT

The present invention discloses systems and methods for creating and managing financial instruments and indexes comprised of securities for companies in subsectors of the economy. These financial instruments allow investment in subsectors of the economy will still being able to minimize risk by diversification. The indexes serve as benchmarks for companies in the subsectors of the economy. A procedure may be used to identify the securities to include in the financial instruments. This procedure may include (a) identifying securities for companies in a sector of the economy; (b) limiting the identified securities to those for companies in a subsector of the sector of the economy; (c) applying focus rules to further limit the identified securities to those for companies who are focused in the subsector of the economy; and (d) limiting the securities included in the financial instrument or index to those that satisfy other objective criteria.

### CROSS-REFERENCE TO RELATED APPLICATIONS

This application claims the benefit of U.S. Provisional Application No. 60/778,492, which was filed Mar. 1, 2006 and is incorporated herein by reference in its entirety.

### FIELD OF THE INVENTION

The present invention relates generally to financial investments, and more particularly to financial investments and related indices and systems for structuring investments in equities for a defined subsector of the economy.

### BACKGROUND OF THE INVENTION

Portfolio investing is a common way to mitigate the risk often associated with investing in stocks, bonds and other types of investments. One type of portfolio investing involves investment in index funds, whose investment objective typically is to achieve the same return as a particular market index.

A market index generally tracks the performance of a specific “basket” of stocks considered to represent a particular market of the stock market or economy. For example, the Dow Jones Industrial Average (DJIA) is an index of 30 “blue chip” U.S. stocks of industrial companies (excluding transportation and utility companies). Similarly, the S&P 500 Composite Stock Price Index is an index of 500 stocks from major industries of the U.S. economy.

Index funds include mutual funds, unit investment trusts (UITs), exchange-traded funds (ETFs) and other types of investments whose objective is to achieve the same return as a particular market index. An index fund will attempt to achieve its investment objective primarily by investing in the securities (stocks or bonds) of companies that are included in a selected index. Some index funds may also use derivatives (such as options or futures) to help achieve their investment objective. Some index funds invest in all of the companies included in an index; other index funds invest in a representative sample of the companies included in an index. Some of similarities and differences among the aforementioned types of index funds are described below.

A mutual fund is a company that pools money from many investors and invests the money in stocks, bonds, short-term money-market instruments, or other securities. Legally known as an “open-end company,” a mutual fund is one of the three basic types of investment companies (the two other basic types are closed-end funds, including UITs, and face-amount certificate companies). Traditionally, investors purchase mutual fund shares from the fund itself (or through a broker for the fund). The shares are not listed on any exchange and there is no organized secondary market, such as the New York Stock Exchange or Nasdaq Stock Market, to enable investors to buy and sell shares. The price investors pay for mutual fund shares is the fund's per share net asset value (NAV) plus any shareholder fees that the fund imposes at purchase (such as sales loads). Mutual funds are redeemable (they can be sold back to the fund) at their approximate NAV, minus any fees the fund imposes at that time.

An ETF is a type of investment company whose investment objective is to achieve the same return as a particular market index. An ETF will primarily invest in the securities of companies that are included in a selected market index. For example, one type of ETF, known as Spiders or SPDRs, invest in all (or most) of the stocks contained in the S&P 500 Composite Stock Price Index. Although ETFs are legally classified as open-end companies or UITs, they differ from traditional open-end companies and UITs in several respects. First, ETFs do not sell individual shares directly to investors and only issue their shares in large blocks (e.g., 50,000 shares) called “creation units.” The creation units are purchased at NAV. Second, after purchasing a creation unit, an investor often splits it up and sells the individual shares on a secondary market. This permits other investors to purchase individual shares (instead of creation units) at market rates (as opposed to NAV) during regular trading hours. Creation units are not purchased with cash, but instead the buyer must make an in-kind contribution of securities that match the index composition underlying the ETF. Alternatively, investors can sell the creation units back to the ETF at or around NAV or sell smaller denominations on the secondary market at market prices. In addition, ETFs generally redeem creation units by giving investors the securities that comprise the portfolio instead of cash.

Because the investment objectives, policies and strategies of an index fund require it to purchase primarily the securities contained in an index, the fund will be subject to the same general risks as the securities that are contained in the index. Further, the management of index funds is more “passive” than the management of non-index funds, because an index fund manager only needs to track a relatively fixed index of securities. This usually translates into lower fees and expenses than more actively managed funds.

Despite these known methods for selecting and managing portfolio investments, there is still a need for innovative systems and methods for establishing and managing investments that allow investors opportunities for investment in significant subsectors of various economies and securities markets (particularly those subsectors exhibiting technological change) while still mitigating the risk associated with investing. For example, during the 1990s, numerous internet companies were formed. Over time, some of those companies floundered, while others were tremendous successes. Thus, a financial instrument for a subcategory of internet companies could have been established focusing on, for example, the on-line book retailer subsector. Such an instrument could have produced significant returns—despite the companies that failed—because of the overwhelming success of other companies in that sub-sector.

This type of a financial instrument would allow participants to reap the benefits of portfolio investing, while still being able to both respond to specific new developments and encourage the development of new products by investing in subsectors of the economy.

### SUMMARY OF THE INVENTION

The present invention discloses systems and methods for creating a financial instrument for investing in securities of companies in a subsector of the economy, systems and methods for creating a financial index comprised of securities of companies in a subsector of the economy, as well as systems and methods for managing financial instruments and indexes of securities for companies in a subsector of the economy.

In one embodiment, the systems and methods of the present invention comprise: (a) identifying securities for companies in a sector of the economy; (b) limiting the identified securities to those for companies in a subsector of the sector of the economy; (c) applying focus rules to further limit the identified securities to those for companies who are focused in the subsector of the economy; and (d) limiting the securities included in the financial instrument or index to those that satisfy other objective criteria. Preferably, the sector of the economy is healthcare.

In one embodiment, a system and method for creating and managing a financial instrument and/or index is disclosed, the system and method comprising defining a subsector of the economy based on development of individual technologies. For example, the basic technology could be selected from the group consisting of diagnostics, cardio devices, orthopedic repair, enabling technologies, European drugs, European medical products and devices and Asian healthcare.

In another embodiment, the system and method comprise defining a subsector by disease application. For example, the disease application could be respiratory or pulmonary diseases, cancer, derma or wound care, ophthalmology, infectious diseases, metabolic or endocrine disorders, autoimmune disorders, CNS disorders, cardiology, genitourinary, gastrointestinal, sexual dysfunction, reproductive health or inflammatory disorders.

In yet another embodiment, a system and method for creating and managing a financial instrument and/or index is disclosed, the system and method comprising identifying a sector or subsector by reference to a database specific for the sector of the economy. For example, the database for the healthcare sector could be BioCentury's database, MedTrack's database, or MedTech Insight's database. A further embodiment comprises identification of securities for companies described in the database as engaged in the sector or subsector.

In a further embodiment of the invention, the system and method comprise applying additional “focus rules” or criteria to limit the identified securities to those with a nexus to the subsector. The nexus can be a commercial nexus shown, for example, by the security's issuer (a) marketing products in the identified subsector; (b) having clinical trials in the identified subsector; or (c) both.

The nexus can also be a research nexus shown, for example, by (a) an indicator of the security issuer's research emphasis in the identified category or subsector; or (b) a ratio between the security issuer's research emphasis in the identified category or subsector and all products marketed by the issuer. The indicator of the security issuer's research emphasis in the subsector can be the number of clinical trials in the identified subsector.

In another embodiment, the additional rules or criteria of the present invention show an over all intensity and business focus of the security's issuer to the identified subsector. The overall intensity and business focus of the security's issuer can be shown by the company possessing a ratio between the sum of the company's number of products and an indicator of the company's research emphasis in a particular subsector, and all of the company's products. An indicator of the security issuer's research emphasis can be the number of clinical trials in the identified subsector.

In yet another embodiment of the present invention, additional objective criteria are used to limit the securities for inclusion in the financial instrument or index. For example, the security's issuer may be required to have a market capitalization with a defined range over a period of time. Preferably, the range is greater than about $100 million, but less than about $15 billion during at least two of the preceding three quarters.

Objective criteria for limiting the inclusion of securities in the financial instruments and indexes of the present invention may also include, for example, requiring the security to be listed on an exchange, such as a major U.S. exchange or foreign exchange; or having depository receipts in either American (ADR) or global (GDR) form listed on a major U.S. or foreign exchange. In another embodiment, securities may be limited to securities for companies that are headquartered in a particular location or listed on a particular stock exchange.

Securities may also be limited by other objective criteria, such as a security issuer with less than a predetermined amount of annual revenues from product sales may be required to have at least the equivalent of one year's operating costs in cash on its balance sheets.

Those and other aspects, objects, advantages and features of the invention will be apparent to those persons skilled in the art upon reading the disclosure of the invention as more fully described below.

### BRIEF DESCRIPTION OF THE DRAWINGS

FIG. 1 shows one embodiment of the present invention to create an ETF.

FIG. 2 further shows one embodiment of the present invention to create an ETF.

### DETAILED DESCRIPTION OF THE INVENTION

The present invention provides systems and methods for creating and managing indexes and financial instruments, which offer fund shares that are listed on recognized stock exchanges. For clarity of disclosure, and not by way of limitation, the detailed description of the invention hereinafter is divided into the subsections that follow. Although many methods similar or equivalent to those described herein can be used in the practice of the present invention, the preferred methods and materials are now described. The provision and discussion of specific examples herein are for illustrative purposes only and are not intended to limit the scope of the present invention.

### A. Definitions

Unless defined otherwise, all technical and scientific terms used herein have the same meaning as is commonly understood by one of ordinary skill in the art to which this invention belongs.

As used herein, the singular forms “a”, “an”, and “the” mean “at least one” or “one or more” unless the context clearly dictates otherwise.

As used herein, “index administrator” means any person, organization, company or the like responsible for index maintenance, including, but not limited to, monitoring and implementing adjustments, additions and deletions, share changes, stock splits, dividends, and stock price adjustments due to restructurings, spin-offs, and other corporate actions.

As used herein, “calculation agent” means any person, organization, company or the like responsible for compiling, calculating, maintaining, and disseminating the values of the indices. For example, Standard & Poor's (“S&P”), a division of The McGraw Hill Companies, Inc. could serve as the calculation agent.

As used herein, “spin-off” means the distribution to existing shareholders of a part of a company's business through the issuance of shares in the newly established company. Both the distributing and newly established company can be evaluated at the next quarterly rebalancing to ensure continued and possibly new compliance with inclusion criteria for an index.

As used herein, the “healthcare” sector is to be interpreted broadly to include any industry where efforts are made to maintain or restore an individual's health. Industries or categories under this definition, include, but are not limited to pharmaceutical, biotechnology, life science, therapeutics, nutraceutical, medical device and the like. Additionally, the healthcare sector includes those companies making and/or enabling tools and technologies for use in these industries.

As used herein, the “diagnostics” subsector is to be interpreted broadly to include any company associated with the identification of the existence or extent of a disease, a visual localization of disease by way of imaging, the selection of therapeutic agents appropriate for the disease wherever possible (“theranostics”) and monitoring of disease progression/therapeutic efficacy.

As used herein, the “respiratory/pulmonary” subsector is to be interpreted broadly to include any company involved with the research, development or commercialization of therapeutic agents treating various respiratory and/or pulmonary diseases, including, but not limited to, asthma, chronic obstructive pulmonary disease, emphysema, tuberculosis, pulmonary arterial hypertension and the like.

As used herein, the “cancer” subsector is to be interpreted broadly to include any larger company involved in the research, clinical development or commercialization of therapeutic agents for the treatment of a wide variety of cancers, and generally include those with substantial revenues and large, deep research and development programs.

As used herein, the “small cap cancer” or “emerging cancer” subsector is to be interpreted broadly to include any smaller-sized company involved in the research, clinical development or commercialization of therapeutic agents for the treatment of a wide variety of cancers, and generally include those with some level of revenues, or on the verge of revenues and have significant but unfocused research and development programs.

As used herein, the “derma and wound care” subsector is to be interpreted broadly to include any company involved in the research, development or commercialization of therapeutic agents for the treatment of a wide variety of skin disorders, including, but not limited to acne, rosacea, psoriasis, genital warts, atopic dermatisis and the like, by topical or systemic means, and/or provide traditional and innovative means of handling wound care problems.

As used herein, the “ophthalmology” subsector is to be interpreted broadly to include any company involved in the research, development or commercialization of therapeutic agents for the treatment of various disease of the eye, including, but not limited to, age-related macular degeneration, dry-eye, diabetic macular edema, glaucoma, presyopia, myopia, and the like.

As used herein, the “infectious disease” subsector is to be interpreted broadly to include any company involved in the research, development or commercialization of therapeutic agents for the treatment of various diseases of the eye including, but not limited to, bacterial infections, fungal infections, viral infections, parasite infections, and the like.

As used herein, the “metabolic-endocrine disorders” subsector is to be interpreted broadly to include any company involved in the research, development or commercialization of therapeutic agents for treatment of a wide variety of metabolic and endocrinal disorders, including, but not limited to, diabetes, obesity, Syndrome X, growth deficiency, rare lysosomal disorders and the like.

As used herein, the “autoimmume-inflammation” subsector is to be interpreted broadly to include any company involved in the research, development or commercialization of therapeutic agents for the treatment of a wide variety of inflammatory disorders, including, but not limited to, osteoarthritis and the like, and autoimmune disorders, including, but not limited to, rheumatoid arthritis, allergies, multiple sclerosis, psoriasis, lupos and the like.

As used herein, the “central nervous system”, “CNS” or “neuroscience” subsector is to be interpreted broadly to include any company involved in the research, development or commercialization of therapeutic agents for the treatment of a wide variety of neurological and psychiatric disorders, including, but not limited to, Alzheimer's, Parkinson's, Huntington's, schizophrenia, anxiety, depression, epilepsy, pain, sleep disorders and the like.

As used herein, the “cardiology” sub-sector should be interpreted broadly to include any company involved in the research, development or commercialization of therapeutic agents for the treatment of cardiologic indications, including, but not limited to, atherosclerosis, coronary artery disease, congestive heart failure, stroke, hypertension, hypotension, thrombosis, restenosis and the like.

As used herein, the “gastrointestinal”, “GI”, “genitourinary” and/or “gender health” sub-sector should be interpreted broadly to include any company involved in the research, development or commercialization of therapeutic agents for the treatment of a wide variety of diseases, including, but not limited to, gastro-intestinal disorders, such as gastroesophageal reflux disease, heartburn, irritable bowel syndrome, Crohn's disease, and ulcerative colitis; genitourinary disorders, such as overactive bladder, urge incontinence, stress incontinence and urinary tract infection; and gender health matters, including sexual dysfunction (male and female), endometriosis, benign prostatic hyperplasia, prolapsed womb, reproductive health and the like.

As used herein, the “cardio devices” sub-sector should be interpreted broadly to include any company involved in the manufacture, distribution or commercialization of medical devices for the treatment of cardiac, vascular and endovascular disorders and diseases, including, but not limited to, stents, valves, patches, pumps, defibrillators, pacemakers, sutures and sensors/chips.

As used herein, the “orthopedic repair” sub-sector should be interpreted broadly to include any company involved in the manufacture, distribution or commercialization of medical devices, pharmaceuticals and regenerative medicine for the treatment of bone, cartilage, tendon, muscle, ligament, maxillofacial and dental elements excluding periodontal and skin conditions or disorders.

As used herein, the “enabling technologies” sub-sector should be interpreted broadly to include any company involved in providing technology products and/or services that enable and support the discovery, clinical development and manufacturing activities of pharmaceutical and biotechnology companies, including, but not limited to, genomics, proteomics, high throughput screening, high content analysis, arrays, combinatorial and evolutionary chemistry, reagents, laboratory/production robotics, analytic instruments and sensors.

As used herein, the “patient care services” sub-sector should be interpreted broadly to include any company involved in providing direct treatment of patients in hospitals, outpatient clinics, nursing homes, assisted living centers, treatment facilities or at home.

As used herein, the “European drugs” sub-sector should be interpreted broadly to include any company headquartered in Europe and involved in the research, development, manufacture or commercialization of pharmaceutical products, small molecule/chemical moieties, biologics (proteins, peptides, oligonucleotides and cell/gene therapies) and vaccines, in all therapeutic categories, primarily intended for humans.

As used herein, the “European medical products and devices” sub-sector should be interpreted broadly to include any company headquartered in Europe and involved in the research development, manufacture, distribution or commercialization of medical devices and/or products for the treatment or amelioration of human disorders and diseases.

As used herein, the “Asian healthcare” sub-sector should be interpreted broadly to include any company headquartered in Asia and involved in the research, development, manufacture or commercialization of therapeutic agents; the in vivo or in vitro diagnostic identification and analysis of disease in humans; or the research, development, manufacture, distribution or commercialization of medical devices and/or products for the treatment or amelioration of human disorders or diseases.

As used herein, “therapeutic agents” is to be interpreted broadly to including anything of or relating to the treatment of a disease or disorder. Without limiting the scope of this definition, “therapeutic agent” includes, but is not limited to, small molecule pharmaceuticals, proteins and enzymes, nucleic acids, antibodies, medical devices, diagnostic kits and assays, implanted devices (e.g., stents, slow release drug delivery systems) and the like.

### B. Identification of Securities

An object of the present invention is to provide for a novel method of creating investment portfolios selected from within a broad area of economic activity (e.g., healthcare) and to provide for differentiation of such portfolios from those selected by other means. In other words, systems and methods are disclosed for selecting securities for inclusion in indexes and funds, as well as systems and methods for managing the resulting indexes and funds, which focus on specific industry subsectors.

In one embodiment of the present invention, multiple funds are established and each fund is invested in a portfolio of securities that replicate or represent a particular index, which measures and monitors the performance of publicly-listed companies in a particular subsector of the economy. In other words, each fund focuses on a different index, which is developed using a vertical investment approach that categorizes companies within a particular index by focusing on each company's investments or products in specific predetermined areas. Other embodiments are envisioned where only one fund is established, and that fund is invested in a portfolio of securities that replicate or represent a particular index.

The systems and methods of the present invention offer several advantages. First, the financial investments and indices of the present invention permit diversification of investments in subsectors defined by specific technologies or business plans. The indices of the present invention may serve as benchmarks for portfolio managers and investors who invest in the securities of companies in various subsectors of industries. The indices may also act as a performance yardstick for companies in the selected subsector. The indices may also serve as vehicles for directing attention to the growing importance of the specified subsectors in the U.S. and global economy, and act as continuous indicators for technological developments in subsectors of industries.

To accomplish the purposes of the invention, securities must be issued by a company whose business lies in the chosen subsector of the economy to be eligible for inclusion in an investment or index. Thus, the present invention provides methods and systems, including rule sets, standards and other objective and subjective criteria, for selecting securities issued by a company whose business lies in the chosen subsector of the economy.

In one embodiment, for example, the systems and methods of the invention disclose identifying potentially eligible securities by: (a) identifying securities for companies in a sector of the economy (e.g., companies in the healthcare industry); (b) limiting the identified securities to those for companies in a subsector of the sector of the economy (e.g., cancer); (c) applying focus rules to further limit the identified securities to those for companies who are focused in the subsector of the economy; and (d) limiting the securities included in the financial instrument or index to those that satisfy other objective criteria.

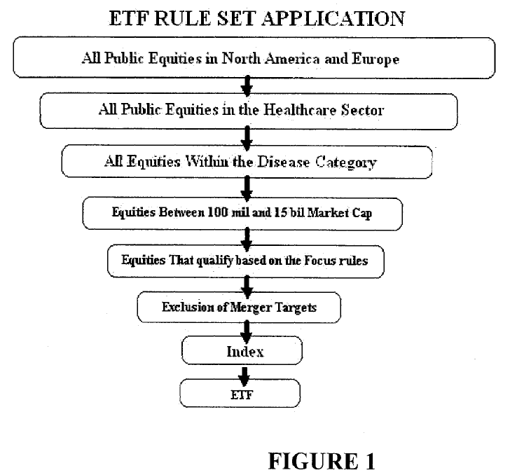

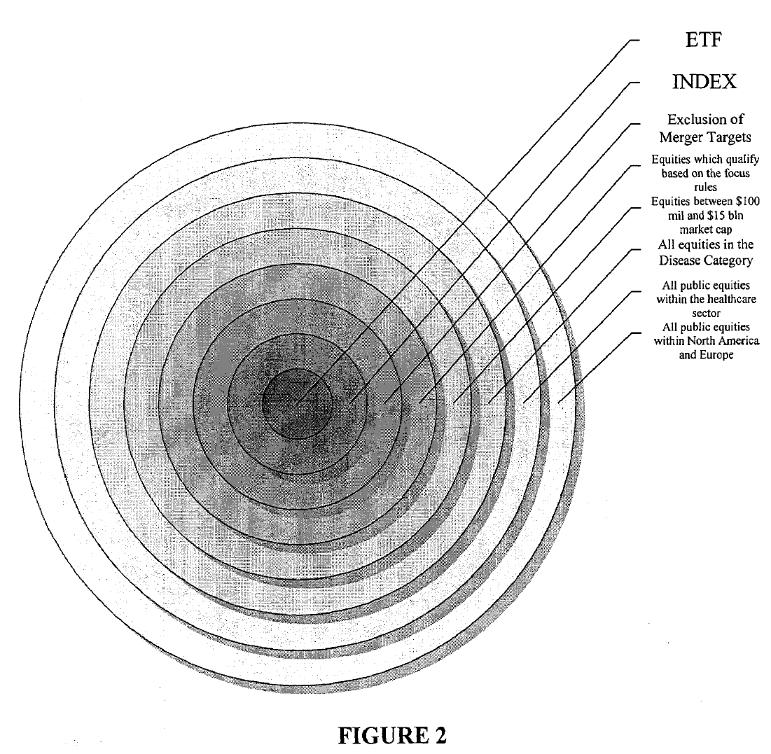

FIGS. 1 and 2 provide a general illustration of this exemplary embodiment. First, a sector of the economy is chosen and securities are identified out of all the securities within North American and Europe for companies in the chosen sector. In FIGS. 1 and 2 securities for companies in the healthcare sector are identified. Companies within a subsector of the chosen sector are then identified and narrowed by application of specific rules and other criteria to arrive at the securities that are included in the index and/or investment vehicle of the present invention. In the embodiment illustrated in FIGS. 1 and 2, securities are limited to those for companies engaged in a specific disease category. The securities are then further limited. First, only securities for companies that have a market capitalization between $100 million and $15 billion are kept. Second, exclusionary criteria or focus rules are used to further limit the remaining securities to those for companies that accurately represent the chosen subsector of the economy. Further description of these steps is provided below.

Specifically, and without limiting the generality of the invention, subsectors may be identified based on the development of individual technologies and applications within broadly defined fields. In one embodiment, a system and method for creating and managing a financial instrument and/or index is disclosed, the system and method comprising defining a subsector of the economy based on development of individual technologies. In the healthcare industry, for example, the basic technology could be diagnostics or tools for research in the healthcare industry. In other fields of endeavor, subsectors could be defined by involvement in hydrogen fuel-cell research.

Subsectors can also be defined by any other criteria suggestive of a company's area of focus. For example, subsectors could be defined by the time of year during which the company generally has its peak performance (e.g., companies with peak sales in the summer or winter) or the market sought to be targeted by the company (e.g., on-line retailers of books). Likewise, subsectors in the healthcare industry could be defined by disease application. For example, the disease application could be respiratory or pulmonary diseases, cancer, derma or wound care, ophthalmology, infectious diseases, metabolic or endocrine disorders, autoimmune disorders, CNS disorders, cardiology, genitourinary, gastrointestinal, sexual dysfunction, reproductive health or inflammatory disorders.

In one preferred embodiment of the present invention, a company's particular business sector and/or subsector can be objectively determined by referring to one or more reputable databases known to those of ordinary skill in the art to ascertain whether the company is either (1) listed as providing products in the relevant sector or subsector corresponding to the component security's subject index, or (2) classified or described as a company engaged in the relevant sector or subsector corresponding to the component security's subject index.

For example, in an embodiment relating to potential healthcare companies for inclusion in an infectious disease index, eligible securities can be determined by reference to reputable databases, such as BioCentury's (www.biocentury.com) or MedTrack's (www.medtrakservices.com) database, to ascertain whether the company provides products corresponding to the infectious disease index. In yet another exemplary embodiment relating to potential companies for inclusion in an ophthalmology index, securities must be issued by companies that have been classified or described by databases, such as MedTech Insight (www.medtechinsight.com), as an opthalmology company in order to be eligible for consideration for inclusion in the Opthalmology Index.

Individual companies within a sector (e.g., healthcare) may be engaged in more than one subsector (e.g., companies with products and/or clinical trials in diverse areas such as cancer and infectious diseases). Thus, to accomplish the aforementioned advantages, the present invention provides further systems and methods for limiting the identified companies to those companies, which are representative, or share common attributes, with companies in the identified subsector.

For example, potentially eligible securities may also be required to show a nexus to the specific index by complying with one or more “focus rules,” which are generally Boolean rules that qualify equities with sufficient operational focus in a given subsector. The nexus between the issuer and the specific index can include using objective criteria to identify a commercial nexus, a research nexus or an overall intensity and business focus of the issuer to that index relative to any other specific index as described in the following paragraphs.

In one embodiment, a commercial nexus may be shown between the issuer and the specific category by the issuer possessing either a predetermined number of marketed products in the specific subsector and a predetermined number of other activities indicative of commercial activity in the subsector; or just a relatively higher predetermined number of marketed products in that subsector. For example, a commercial nexus may be shown between the issuer and the diagnostics subsector by the issuer possessing either a predetermined number of marketed diagnostics products and a predetermined number of clinical trials running in that subsector; or just a relatively higher predetermined number of marketed diagnostics products. Preferably for healthcare companies, the predetermined number of marketed products and the predetermined number of clinical trials is greater than about ten and greater than about one, respectively; or alternatively the relatively higher predetermined number of marketed products is greater than about twenty.

In another embodiment, a research nexus may be shown between the issuer and the specific subsector by the issuer either possessing a predetermined ratio between an indicator of its research emphasis in the specific subsector to all products marketed by the issuer; or possession of at least a predetermined number of indicators of its research emphasis in the specific subsector. For example, in an embodiment for a therapeutically oriented company, a research nexus may be shown by a predetermined ratio between its clinical trials in the specific subsector to all products marketed by the issuer; or possession of at least a predetermined number of clinical trials in the specific subsector. The preferred ratio in this exemplary embodiment is greater than about 0.35, but less than about one, and the preferred predetermined number of clinical trials is greater than about five.

In yet another embodiment, an overall intensity and business focus of the issuer to the specific index may be shown by the issuer possessing a pre-determined ratio between the sum of the company's number of products sold plus an indicator of the company's research emphasis in a particular sub-sector, and all the company's products. In one exemplary embodiment directed at therapeutically oriented companies, an overall intensity and business focus of the issuer to the specific index may be shown by the issuer possessing a pre-determined ratio between the sum of the company's number of products sold plus the company's clinical trials in the therapeutic category, and all the company's products (either in trial stage or actively marketed). In a preferred embodiment for therapeutically oriented companies, the predetermined ratio is between about 0.5 and 1.0.

Additional criteria are contemplated in further embodiments to ensure that the potentially eligible securities are issued by a company whose business lies in the chosen subsector of the economy. For example, potentially eligible securities may be required to have a market capitalization between a pre-determined minimum and a pre-determined maximum value over a given period of time. Such a requirement will eliminate companies from consideration that likely have too broad a focus (e.g., products or research in too many sub-sectors) for inclusion in any one subsector. For example, it may not be desirable to include large pharmaceutical companies within an given index because they have products related to a large number of subsectors. Accordingly, a person of skill in the art could establish a pre-determined maximum and pre-determined minimum market capitalization for a given period of time to exclude companies that are not truly focused on a given index.

Preferably, the pre-determined minimum is selected from the group consisting of about $50 million, about $75 million, about $100 million, about $125 million, about $150 million and about $350 million; said pre-determined maximum is selected from the group consisting of about $10 billion, about $15 billion, about $20 billion and about $25 billion; and said period of time is selected from the group consisting of at least one of the three preceding quarters, at least two of the preceding three quarters, three of the preceding three quarters, at least two of the preceding four quarters, at least three of the preceding four quarters and four of the preceding four quarters. In one preferred embodiment for therapeutically oriented companies, the pre-determined minimum is greater than about $100 million; the pre-determined maximum is less than about $15 billion; and the period of time is at least two of the preceding three quarters. Other embodiments may use any other pre-determined minimum, pre-determined maximum and time periods as determined appropriate by a person of ordinary skill in the art.

Further embodiments may impose additional objective criteria, such as a requirement that all potentially eligible securities be listed for trading on one of the major U.S. exchanges, including The New York Stock Exchange (NYSE), The American Stock Exchange (AMEX) or The Nasdaq Stock Market (NASDAQ); on a foreign or major Canadian stock exchange; or have depositary receipts in either American (ADR) or global (GDR) form listed on one of the aforementioned exchanges. Additionally, potentially eligible securities may be limited to common equity securities, and not quasi-debt securities, such as convertible securities.

Potentially eligible securities may also be limited to securities for companies that are headquartered in particular locations and/or quoted on at least one stock exchange in that location. In one embodiment, potentially eligible securities are limited to securities for companies headquartered in the location selected from the group consisting of North America, South America, Australia, Europe, Asia and Africa. In alternative embodiment, potentially eligible securities are limited to securities for companies headquartered in countries selected from the group consisting of Japan, China, India, South Korea, Taiwan, Singapore, Thailand, Malaysia, Indonesia, Philippines or Hong Kong. Potentially eligible securities may also be limited to securities for companies quoted on at least one stock exchange in the desired location, for example, on a European or Asian stock exchange.

In another embodiment, for securities in which the issuer has less than a predetermined amount of annual revenues from product sales (e.g., based on most recent audited financial statements), the issuer of any potentially eligible security may be required to have at least the equivalent of one year's operating costs in cash on its balance sheet. In one preferred embodiment relating to therapeutically oriented companies, the predetermined amount of annual revenues is about $100 million.

A “composite” financial instrument or index is also within the scope of the present invention. Such an instrument or index may consist of a predetermined number of securities contained in other indices focusing on subsectors of the economy. In one embodiment, the composite investment vehicle or index consists of the five largest companies by market capitalization in each of a predetermined number of indices focusing on subsectors of the economy. In a preferred embodiment, the indices focusing on subsectors of the economy are selected from the group comprising diagnostics, respiratory/pulmonary, cancer, emerging cancer, dermatology and wound care, ophthalmology, infectious disease, metabolic-endocrine disorders, autoimmune-inflammation, central nervous system, cardiology and gender health.

These exemplary embodiments are not intended to limit the scope of the invention, and it is anticipated that many additional objective criteria may be established for various subcategories that fall within the scope of the present invention.

For reasons including the mitigation of risk associated with investing in the funds of the present invention, further requirements may be imposed that at least a predetermined amount of issuers satisfy the inclusion criteria for any one index; and a predetermined minimum number of component securities, which is less than the predetermined amount of issuers satisfying the inclusion criteria for any one index, be included in each index. A predetermined number of qualifying securities may be held in reserve. The predetermined minimum number of component securities may vary by the particular subsector or index because some subsectors are larger than others. In one preferred embodiment directed to therapeutically oriented companies, the predetermined amount of issuers is greater than about twenty-three, and the predetermined minimum number of component securities is about twenty.

The index administrator will generally determine which securities are included in each index based on the aforementioned objective criteria.

### C. Management of Investments and Indices

The present invention also provides methods and systems for managing funds, which focus on specific industry subsectors. Portfolios are generally managed by specific individuals or organizations. ETFs are usually managed by an index administrator and/or a calculation agent, while other investments may have a management or other committee. Regardless, the rule sets and criteria of the present invention can be further used to manage such investments and indices.

In one embodiment, decisions regarding additions to and removals from investments and indices can be made based on rules and other criteria (as discussed above). For example, a given security may be removed from an index if at some point it does not satisfy the inclusion rules or criteria for the index in which the component security is contained. The security may then be replaced by another security that does satisfy the inclusion rules or criteria for the index. In this way, the index and fund include only securities for issuers who are truly representative of the target subsector.

With respect to index funds, decisions regarding additions to and removals from indexes are generally made on a quarterly basis. However, securities not satisfying the criteria of the present invention may be removed from the index at any point when such criteria are not met. For example, a security that is the subject of a tender offer may be removed at the earliest of (1) when reasonable evidence (as determined by, e.g., the index administrator or the index committee) that more than a certain percentage of the total underlying shares have been tendered or are likely to be tendered; (2) delisting of the index component from an exchange; or (3) announcement that the tender offer is mandatory. Preferably, such certain percentage in (1) is 80%, but a higher percentage may be preferable in connection with conditional offers. In another exemplary embodiment relating to a therapeutically oriented company, a security may be removed from an index of the therapeutically oriented issuer has a product fail a clinical trial or removed from the market.

Decisions regarding additions and removals can also be made based on a combination of rules and criteria (as discussed above). By way of example, additional criteria resulting in removal of securities from an index may include bankruptcy of the securities issuer; delisting of the issuer's securities from acceptable exchanges; acquisition or merger of the issuer, or announcement of its acquisition or merger, by or into another company that does not satisfy the inclusion criteria for the index in which the component security is contained; lack of reasonable liquidity for the security, defined as no trading activity involving the security on a principal exchange within a certain period of time; or the security no longer meets any of the established objective inclusion criteria.

The present invention may be implemented with any combination of hardware and software. If implemented as a computer-based process or application, the present invention may be implemented using means for performing any or all of the steps and functions described herein

An embodiment of the present invention is further described by reference to the following non-limiting examples of an ETF for the companies relating to the Cancer subsector of the Healthcare sector.

### EXAMPLES

### Step 1—Identification of Companies in the Healthcare Sector

The formation of the Cancer ETF requires application of the generalized rule set described herein. The starting point for defining the ETF is identification of the entire universe of equities on all exchanges within the given area. The ETF is composed of all equities within the American, European, and Canadian markets. This data is readily available for all equities from a plethora of data providers including Bloomberg, Reuters and the exchange websites.

Securities for companies in the healthcare sector are then separated from all of these other securities. The healthcare sector is defined as all publicly traded equities that market or plan to market products or services for the prevention, treatment, and management of illness and/or are involved in clinical trials or in any phase of a regulatory filing for a healthcare product. The data set generated by this rule is based upon information and categorization contained in the widely available healthcare industry specific databases MEDTRACK and BioCentury. The following is the list of companies in the healthcare sector as identified by reference to those databases.

3M Company.
4SC AG
Aastrom Biosciences Inc.
Abaxis Inc.
Abbott Laboratories
Abcam Ltd.
ABIOMED Inc
Able Laboratories Inc.
Abraxis BioScience Inc.
Acacia Research Corp.
Acadia Pharmaceuticals Inc.
Acambis plc
Accelrys Inc.
Accentia Biopharmaceuticals Inc.
Access Pharmaceuticals Inc.
ACI Global Corp
Acorda Therapeutics Inc.
Acrongenomics Inc.
Acrux Ltd.
Actelion Ltd.
Active Biotech AB
Acura Pharmaceuticals Inc.
Acusphere Inc
Acusphere Inc.
Adaltis Inc.
Adams Respiratory Therapeutics Inc.
Adeza Biomedical Corp.
Adherex Technologies Inc.
Adolor Corp.
Advanced Biotherapy Inc.
Advanced Cell Technology Inc.
Advanced Life Sciences Holdings Inc
Advanced Magnetics Inc.
Advanced Medical Solutions Group
plc
Advanced Ocular Systems Ltd.
Advanced Plant Pharmaceuticals Inc.
Advanced Viral Research Corp.
Advancis Pharmaceutical Corp.
Advaxis Inc.
ADVENTRX Pharmaceuticals Inc
Advitech Inc.
Aeolus Pharmaceuticals Inc.
AES Laboratoire Group
AEterna Zentaris Inc
Aethlon Medical Inc
Affymetrix Inc.
AGI Therapeutics plc
Agilent Technologies Inc.
Akesis Pharmaceuticals Inc.
Akorn Inc
Aksys Ltd
Akzo Nobel NV
Albany Molecular Research Inc.
Alchemia Pty. Ltd.
Alcon Inc
Alcon Laboratories Inc.
Alert B&C Corp.
Alexion Pharmaceuticals Inc.
Alexza Pharmaceuticals Inc.
Alfacell Corp.
Alizyme plc
ALK Abello A/S
Alkermes Inc.
Allergan Inc
Allergy Therapeutics plc
Alliance Pharmaceutical Corp.
Allon Therapeutics Inc.
Allos Therapeutics Inc.
Alltracel Pharmaceuticals plc
Alnylam Pharmaceuticals Inc.
Alpha Innotech Corp.
Alpharma Inc.
AlphaRx Inc.
Altair Nanotechnologies Inc.
Altana Aktiengesellschaft
Alteon Inc.
Altus Pharmaceuticals Inc.
Amarillo Biosciences Inc.
Amarin Corporation plc
Amazon Biotech Inc.
Ambrilia Biopharma Inc.
AMDL Inc.
American Bio Medica Corp.
American Medical Systems Holdings
Inc
Amgen Inc.
Amorfix Life Sciences Ltd.
Amylin Pharmaceuticals Inc.
Anadys Pharmaceuticals Inc.
Andrx Corp.
Anesiva, Inc.
Angel Biotechnology Ltd.
AnGes MG Inc.
Angiotech Pharmaceuticals Inc.
Anika Therapeutics Inc.
AnorMED Inc
Antares Pharma Inc.
Antigenics Inc.
Antisense Therapeutics Ltd.
Antisoma PLC
AorTech International plc
AP Pharma Inc.
Aphton Corp.
Apogent Technologies Inc.
Apollo Life Sciences Ltd.
Applied Biosystems Group
Applied Imaging Corp.
Applied NeuroSolutions Inc.
Aqua Bounty Technologies Inc.
Aradigm Corp.
Arbios Systems Inc.
Ardana plc
Arena Pharmaceuticals Inc.
Ariad Pharmaceuticals Inc.
Arius Research Inc.
Ark Therapeutics Group plc
Arpida Ltd.
ArQule Inc.
Array BioPharma Inc.
Arrowhead Research Corp.
Arthro Kinetics plc
Ascentia Biomedical Corp.
Aspect Medical Systems Inc.
Aspreva Pharmaceuticals Corp.
Astralis Ltd.
AstraZeneca Plc
AtheroGenics Inc.
Atrium Biotechnologies Inc.
Aurobindo Pharma Ltd.
AutoImmune Inc.
Auxilium Pharmaceuticals Inc.
Avalon Pharmaceuticals Inc.
AVANIR Pharmaceuticals
AVANT Immunotherapeutics Inc
Avantogen Ltd.
Avantogen Oncology Inc.
Avax Technologies Inc.
Avexa Ltd.
AVI BioPharma Inc.
Avicena Group Inc.
Avigen Inc.
Avitar Inc.
Axcan Pharma Inc.
Axis-Shield plc
AXM Pharma Inc.
Axonyx Inc.
Bachem AG
Barr Pharmaceuticals Inc.
Barrier Therapeutics Inc.
BASF AG
Basilea Pharmaceutica AG
Bausch & Lomb Incorporated
Bavarian Nordic AS
Baxter International Inc
Bayer Ag
BCY LifeSciences Inc.
Beckman Coulter Inc.
Becton Dickinson and Company
Benitec Ltd
Bentley Pharmaceuticals Inc.
Biacore International AB
Bioaccelerate Holdings Inc.
BioAlliance Pharma S.A.
Bioanalytical Systems Inc.
Bio-Bridge Science Inc.
Biocompatibles International plc
Biocon Ltd.
BioCryst Pharmaceuticals Inc.
BioCurex Inc.
BioDelivery Sciences International
Inc.
Bioenvision Inc.
Biofield Corp.
Bio-Fluorescent Technologies Inc.
BioForce Nanosciences Holdings Inc.
Biofusion plc
BioGaia Biologics
Biogen dec Inc.
BioInvent International AB
Bioject Medical Technologies Inc.
BioLase Technology Inc
BioMarin Pharmaceutical Inc.
Biomerica Inc.
BioMimetic Therapeutics Inc.
Biomira Inc.
BioMS Medical Corp.
Bioniche Life Sciences Inc.
Bionomics Ltd.
Bionovo Inc.
Biophage Pharma Inc.
BioPhausia AB
Bioprogress plc
Biopure Corp.
Biopure Corporation
Bio-Rad Laboratories Inc.
BioReliance Corp.
BioSante Pharmaceuticals Inc.
Bioscan A/S
Biosite Inc.
BioSpecifics Technologies Corp.
BioSphere Medical Inc.
BioSyntech Inc.
Biota Holdings Ltd.
Biotage AB
Biotec Pharmacon ASA
Biotech Holdings Ltd.
Biotest AG
BioTie Therapies Corp.
BioTime Inc.
Biotrace International plc
Biovail Corporation
BioVeris Corp.
Bioxel Pharma Inc.
BioXell S.p.A.
Bone Medical Ltd.
Boston Life Sciences Inc.
Boston Scientific Corporation
Bradley Pharmaceuticals Inc.
Bradmer Pharmaceuticals Inc.
Brainstorm Cell Therapeutics Inc
BresaGen Ltd.
Bristol-Myers Squibb Company
Bruker BioSciences Corp.
CABG Medical Inc.
Cadus Corp.
CalbaTech Inc.
Caliper Life Sciences Inc.
Callisto Pharmaceuticals Inc.
Calypte Biomedical Corporation New
Cambrex Corp.
Cambridge Antibody Technology
Group plc
Cambridge Heart Inc
Can-Fite BioPharma Ltd.
Cangene Corp.
Caraco Pharmaceutical Laboratories
Ltd
Cardiac Science Corp
Cardima Inc
Cardinal Health Inc.
CardioGenesis Corporation
Cardiome Pharma Corp.
CardioVascular BioTherapeutics Inc.
Cardium Therapeutics Inc.
Carribbean American Health Resorts
Inc
Carrington Laboratories Inc.
Celera Genomics Group
Celgene Corporation
Cell Genesys Inc
Cell Genesys Inc.
Cell Therapeutics Inc.
Cellegy Pharmaceuticals Inc.
Cellestis Ltd.
CEL-SCI Corporation
Celsion Corp
Celsion Corp.
Celsis International plc
CeNeS Pharmaceuticals Plc
Cephalon Inc.
Cepheid Inc.
CepTor Corp.
Ceragenix Pharmaceuticals Inc.
Cerep S.A.
Cerus Corp.
Cerus Corporation
Charles River Laboratories Inc.
Chattem Inc
Chelsea Therapeutics International
Ltd.
Chembio Diagnostics Inc.
ChemGenex Pharmaceuticals Ltd.
Chemokine Therapeutics Corp.
Chesapeake Biological Laboratories
Inc.
Cholestech Corporation
ChondroGene Ltd.
ChromaVision Medical Systems Inc.
Chromos Molecular Systems Inc.
Cipher Pharmaceuticals Inc.
Ciphergen Biosystems Inc.
Clavis Pharma AS
Cleveland BioLabs Inc.
Clinical Data Inc.
Clinicor Inc.
Clinuvel Pharmaceuticals Ltd.
Closure Medical Corp.
CN Biosciences Inc.
co.don AG
Cobalis Corp.
Cobra Biomanufacturing plc
Coley Pharmaceutical Group Inc
CollaGenex Pharmaceuticals Inc.
Columbia Laboratories Inc.
CombiMatrix Corp.
CombinatoRx Inc.
Commonwealth Biotechnologies Inc.
Compugen Ltd.
Conceptus Inc.
ConjuChem Biotechnologies Inc.
Connetics Corporation
Conor Medsystems Inc.
Corautus Genetics Inc.
Corcept Therapeutics Inc.
Corgenix Medical Corp.
Cortex Pharmaceuticals Inc.
CoTherix Inc.
Cozart plc
Critical Therapeutics Inc.
Crucell N.V.
Cryo-Cell International Inc.
CryoLife Inc.
CSL Ltd.
Cubist Pharmaceuticals Inc.
CuraGen Corp.
Curalogic A/S
Curasan Pharma GmbH
Curative Health Services Inc.
Curidium Medica plc
Curis Inc.
Curon Medical Inc
CV Technologies Inc.
CV Therapeutics Inc
CV Therapeutics Inc.
Cyanotech Corporation
CyBio AG
Cyclacel Pharmaceuticals Inc.
CyGene Laboratories Inc.
CyGenics Ltd.
Cygnus Inc.
Cypress Bioscience Incorporated
Cyprotex plc
CytoCore Inc.
CytoDyn Inc
CYTOGEN Corporation
CytoGenix Inc.
Cytokinetics Inc.
Cytomedix Inc.
Cytomyx Holdings plc
Cytori Therapeutics Inc.
Cytos Biotechnology AG
CytRx Corporation
Cytyc Corp.
Dade Behring Inc.
deCode genetics Inc.
Delcath Systems Inc
Deltagen Inc
Dendreon Corp
Dendreon Corp.
DepoMed Inc
Derma Sciences Inc
Devgen N.V.
DiaGenic ASA
DiagnoCure Inc.
Diametrics Medical Inc.
Diamyd Medical AB
DiaSys Corp.
Digene Corp.
Diomed Holdings Inc
Discovery Laboratories Inc.
Discovery Partners International Inc.
Diversa Corp.
DNAPrint genomics Inc.
Donlar Corp.
DOR BioPharma Inc
Dov Pharmaceutical Inc.
Dragon Pharmaceuticals Inc.
DRAXIS Health Inc
Duravest Inc.
DURECT Corporation
DUSA Pharmaceuticals Inc.
Duska Therapeutics Inc.
Dyadic International Inc.
Dyax Corp.
Dynavax Technologies Corp.
Ecopia BioSciences Inc.
Eden Bioscience Corp.
Edwards Lifesciences Corporation
eGene Inc.
EiRx Therapeutics plc
Elan Corp. plc
Eli Lilly & Co
Elite Pharmaceuticals Inc.
Elron Electronic Industries Ltd
Embrex Inc.
Emisphere Technologies Inc.
Encysive Pharmaceuticals Inc.
Endo Pharmaceuticals Holdings Inc.
Endologix Inc
Endovasc Ltd. Inc.
Enhance Biotech Inc.
Entelos Inc.
EntreMed Inc.
Entropin Inc.
Enzo Biochem Inc.
Enzon Pharmaceuticals Inc.
EpiCept Corp.
Epigenomics AG
EPIX Pharmaceuticals Inc
EQiTX Ltd
Ergo Science Corporation
Eurofins Scientific S.A.
EvoGenix Pty. Ltd.
Evolutec Group plc
Evotec AG
Exact Sciences Corporation
Exactech Inc
eXegenics Inc.
Exelixis Inc.
Exogen Inc.
ExonHit Therapeutics S.A.
Favrille Inc.
FermaVir Pharmaceuticals Inc.
Fischer Imaging Corp.
Fisher Scientific International Inc.
Flamel Technologies SA ADS
Forbes Medi-Tech Inc.
Forest Laboratories Inc.
Fresenius AG
Fulcrum Pharma plc
Galapagos N.V.
Gambro AB
GammaCan International Inc.
Gedeon Richter Ltd
GelStat Corp.
Genaera Corporation
Gene Logic Inc.
Geneart GmbH
Genelabs Technologies Inc.
GeneMax Corp.
GeneMedix plc
Genentech Inc.
Generex Biotechnology Corporation
GeneScan Europe AG
Genesis Bioventures Inc
Genesis Research and Development
Corp.
Genetic Technologies Ltd.
Genetix Group plc
Genitope Corp.
Genmab A/S
Genomic Health Inc.
Gen-Probe Inc.
Genta Incorporated
Gentium S.p.A.
GenVec Inc.
Genzyme Corporation
GeoPharma Inc.
Geron Corporation
Gilead Sciences Inc.
Girindus AG
Given Imaging Ltd
GlaxoSmithKline plc
Glenmark Pharmaceuticals Ltd.
GlycoGenesys Inc.
Goldshield Group plc
GPC Biotech AG
Grant Life Sciences Inc.
GTC Biotherapeutics Inc.
GTx Inc.
Guidant Corp.
GW Pharmaceuticals PLC
H. Lundbeck AS
Haemacure Corp.
Halozyme Therapeutics Inc.
Hana Biosciences Inc.
Harvard Bioscience Inc.
Health Discovery Corp.
Healthlinx Ltd.
Helix BioMedix Inc.
Helix BioPharma Corp.
Hemagen Diagnostics Inc.
Hemispherx Biopharma Inc.
HemoBioTech Inc.
Hemosol Corp
Henderson Morley plc
Heska Corporation
Hi-Tech Pharmacal Co Inc
Hollis-Eden Pharmaceuticals Inc.
Hologic Inc.
Human Genome Sciences Inc.
Human Pheromone Sciences Inc.
Hutchison China MediTech Ltd.
Ibex Technologies Inc.
ICAgen Inc
ICOS Corp
Idenix Pharmaceuticals Inc.
Idera Pharmaceuticals Inc.
Idexx Laboratories Inc.
IDM Pharma Inc.
IDMoS plc
Igene Biotechnology Inc.
IGI Inc.
Illumina Inc.
Imagenetix Inc.
ImClone Systems Inc.
Imcor Pharmaceutical Co.
Immtech Pharmaceuticals Inc.
ImmuCell Corporation
Immucor Inc.
Immune Network Ltd.
Immune Response Corporation
Immunicon Corp.
ImmunoGen Inc.
Immunomedics Inc.
ImmuPharma plc
Impax Laboratories Inc.
Incitive Ltd.
Incyte Corp.
Incyte Corporation
Indevus Pharmaceuticals Inc.
Inex Pharmaceuticals Corp.
Inflazyme Pharmaceuticals Ltd.
Inhibitex Inc.
Inncardio Inc.
InNexus Biotechnology Inc.
Innogenetics N.V.
Innovata Plc
Inovio Biomedical Corp.
InSite Vision Incorporated
Insmed Incorporated
Inspire Pharmaceuticals Inc.
Integra LifeSciences Holdings Corp.
Integrated Biopharma Inc.
Integrated Pharmaceuticals Inc.
Intercell AG
Intercytex Group plc
Interleukin Genetics Inc.
InterMune Inc.
International Isotopes Inc
IntraBiotics Pharmaceuticals Inc.
Introgen Therapeutics Inc.
Inverness Medical Innovations Inc.
InVitro International
Invitrogen Corp.
Inyx Inc.
Iomai Corp.
Iomed Inc.
Ipsen Group
Isis Pharmaceuticals Inc.
Isolagen Inc.
IsoRay Inc
Isotechnika Inc.
IsoTis Orthobiologics International
Ista Pharmaceuticals Inc.
Japan Tobacco Inc.
Javelin Pharmaceuticals Inc.
Jerini AG
Johnson & Johnson
K V Pharmaceutical Co CL A
Kane Biotech Inc.
Karo Bio AB
Kendle International Inc.
Kent International Holdings Inc
Keryx Biopharmaceuticals Inc.
King Pharmaceuticals Inc.
KOS Pharmaceuticals Inc
Kosan Biosciences Incorporated
Kyowa Hakko Kogyo Ltd.
Kyphon Inc
Kyto BioPharma Inc
La Jolla Pharmaceutical Co.
LAB International Inc.
Labopharm Inc.
LAM Pharmaceutical Corp.
Lannett Contractor Inc
Large Scale Biology Corporation
Lark Technologies Inc.
Lescarden Inc
Lev Pharmaceuticals Inc.
Lexicon Genetics Incorporated
LifeCell Corp.
Lifecore Biomedical Inc.
Ligand Pharmaceuticals Inc.
Lion bioscience AG
Lipid Sciences Inc.
Lipoxen plc
Living Cell Technologies Ltd.
Lorus Therapeutics Inc.
Lpath Inc.
Luminex Corporation
MacroChem Corp.
Magistral Biotech Inc.
Manhattan Pharmaceuticals Inc.
Mannatech Inc
MannKind Corp.
Marc Pharmaceuticals Inc.
Marshall Edwards Inc.
Martek Biosciences Corp.
Matritech Inc.
Matrixx Initiatives Inc
Maxygen Inc.
MDS Inc.
Medarex Inc.
Medical Discoveries Inc.
MedicalCV Inc
Medicines Company
MediciNova Inc.
Medicis Pharmaceutical Corp.
Medicure Inc.
MediGene AG
MedImmune Inc.
MediStem Laboratories Inc.
Meditech Research Ltd.
Medivation Inc.
Medivir Adderall Business
MedMira Inc.
Medtox Scientific Inc
Medtronic Inc.
Memory Pharmaceuticals Corp.
Mentor Corp.
Mera Pharmaceuticals Inc.
Merck & Co Inc
Meridian Bioscience Inc.
Mesoblast Ltd.
Metabasis Therapeutics Inc.
Metabolic Pharmaceuticals Ltd.
MethylGene Inc.
MGI Pharma Inc.
Microbix Biosystems Inc.
MicroIslet Inc.
MicroMed Cardiovascular Inc
Micromet Inc.
Migenix Inc
Migenix Inc.
Millenium Biologix Corp.
Millennium Pharmaceuticals Inc.
Millipore Corp.
Minrad International Inc
Minster Pharmaceuticals plc
Miraculins Inc.
Miravant Medical Technologies Inc.
MIV Therapeutics Inc.
Molecular Devices Corp.
Molecular Pharmacology (USA) Ltd.
Mologen Holding AG
Momenta Pharmaceuticals Inc.
Monogram Biosciences Inc.
Monsanto Company
MorphoSys AG
MultiCell Technologies Inc.
MWG Biotech AG
Mylan Laboratories Inc
Mymetics Corp.
Myogen Inc.
Myriad Genetics Inc.
Nabi Biopharmaceuticals
Nanobac Life Sciences Inc.
Nanogen Inc.
NanoLogix Inc.
Nanophase Technologies
Corporation
NanoViricides Inc.
Nastech Pharmaceutical Co. Inc.
Natrol Inc
Nektar Therapeutics
Neogen Corp.
NeoGenomics Inc.
NeoPharm Inc.
Neoprobe Corp
Neoprobe Corp.
Neose Technologies Inc.
Neuren Pharmaceuticals Ltd.
Neuro Bioscience Inc.
Neurobiological Technologies Inc.
Neurochem Inc.
Neurocrine Biosciences Inc.
NeuroDiscovery Ltd.
Neurogen Corporation
Neuro-Hitech Pharmaceuticals Inc.
Neurologix Inc.
NeuroMedix Inc.
NeuroSearch A/S
NeuTec Pharma plc
New River Pharmaceuticals Inc.
New York Health Care Inc.
Nexia Biotechnologies Inc.
NexMed Inc.
NextGen Group plc
NicOx S.A.
NitroMed Inc.
Nitto Denko Corp.
North American Scientific Inc.
Northfield Laboratories Inc.
Northwest Biotherapeutics Inc
Northwest Biotherapeutics Inc.
Norwood Abbey Ltd.
Norwood Immunology Ltd.
Novacea Inc.
NovaDel Pharma Inc.
Novartis AG
Novavax Inc.
Novelos Therapeutics Inc.
november AG
Noven Pharmaceuticals Inc.
Novogen Ltd.
Novo-Nordisk A
Novoste Corp.
Novozymes A
NPS Pharmaceuticals Inc
NPS Pharmaceuticals Inc.
Nucryst Pharmaceuticals Corp.
NuOncology Labs Inc.
Nutra Pharma Corp.
NutraCea
Nutraceutical International
Corporation
Nutri Pharma ASA
Nutrition 21 Inc.
Nuvelo Inc.
Nuvo Research Inc.
Nventa Biopharmaceuticals Corp.
Nymox Pharmaceutical Corporation
Omrix Biopharmaceuticals Inc.
Oncolytics Biotech Inc.
OncoMethylome Sciences S.A.
Ondine Biopharma Corp
Ono Pharmaceuticals Co. Ltd.
Onyx Pharmaceuticals Inc.
Opexa Therapeutics Inc
Oragenics Inc.
Oramed Pharmaceuticals Inc
OraSure Technologies Inc.
Orchid Cellmark Inc.
Orexo AB
Organic Recycling Technologies Inc
Orion Corp.
Ortec International Inc.
OrthoLogic Corporation
Orthovita Inc.
Oscient Pharmaceuticals Corp.
OSI Pharmaceuticals Inc.
Osteotech Inc.
Oxford BioMedica plc
OXiGENE INC
Oxis International Inc.
Oxonica plc
Pacific Biometrics Inc New
PacificHealth Laboratories Inc
Pain Therapeutics Inc.
Paion AG
Paladin Labs Inc.
Palatin Technologies Inc.
Paligent Inc
Pall Corp.
Panacos Pharmaceuticals Inc.
Par Pharmaceuticals Companies Inc.
Paracelsian Inc.
Parexel International Corp.
Patheon Inc.
PDL BioPharma Inc.
Penwest Pharmaceuticals Co.
Peplin Ltd.
Peptech Ltd.
Peregrine Pharmaceuticals Inc.
PerkinElmer Inc.
Perrigo Co
Pfizer Inc
Pharmacopeia Drug Discovery Inc.
Pharmacyclics Inc.
PharmaFrontiers Corp.
PharmaGap Inc.
Pharmaxis Ltd.
Pharmexa A/S
Pharmion Corp
Pharmos Corp.
Pharmos Corporation
Pharsight Corp.
Phase Forward Inc.
Phase III Medical Inc.
Phoqus Ltd.
Phosphagenics Ltd.
PhotoCure ASA
PhotoMedex Inc
Phylogica Ltd
Phynova Group plc
Physiomics plc
PhytoMedical Technologies Inc.
Phytopharm PLC
PlasmaSelect AG
Plethora Solutions Holdings plc
Pliva d.d.
Pluristem Life Sciences Inc.
Point Therapeutics Inc.
Polydex Pharmaceuticals Ltd.
Poniard Pharmaceuticals Inc.
Power3 Medical Products Inc.
POZEN Inc
PPD Inc.
PRA International Inc.
Praecis Pharmaceuticals
Incorporated
Prana Biotechnology Ltd.
PreMD Inc.
Prescient NeuroPharma Inc.
Pressure BioSciences Inc.
Prima Biomed Ltd.
Probi AB
Procter & Gamble Company
Procyon Corp
ProCyte Corp.
Progen Industries Ltd.
Progenics Pharmaceuticals Inc.
ProMetic Life Sciences Inc.
Pro-Pharmaceuticals Inc.
ProStrakan Group plc
Protalex Inc.
Protein Polymer Technologies Inc.
Proteo Inc.
Proteome Sciences plc
Protherics PLC
Protox Therapeutics Inc.
Provalis plc
Provectus Pharmaceuticals Inc.
Proximagen Neuroscience plc
pSivida Ltd.
Psychemedics Corp
Qiagen N.V.
QLT Inc.
Quest Diagnostics Inc.
Quest PharmaTech Inc.
Questcor Pharmaceuticals Inc.
Quidel Corporation
Quigley Corp.
Raptor Pharmaceutical Inc.
Reckitt Benckiser plc
ReGen Therapeutics plc
Regeneration Technologies Inc
Regeneron Pharmaceuticals Inc.
RegeneRx Biopharmaceuticals Inc.
ReNeuron Ltd.
Renovis Inc.
Renovo Ltd.
Replidyne Inc.
Repligen Corporation
Repros Therapeutics Inc.
Resonance Health Ltd.
Respironics Inc.
Response Biomedical Corp.
Resverlogix Corp.
Rexahn Pharmaceuticals Inc.
Rigel Pharmaceuticals Inc.
Roche Holdings Ltd
Rockeby Biomed Ltd.
Salix Pharmaceuticals Ltd.
Samaritan Pharmaceuticals Inc.
Sangamo BioSciences Inc.
Sangui BioTech International Inc.
Sanguine Corp.
Sanochemia Pharmazeutika AG
Sanofi-Aventis
Santarus Inc.
Sareum Holdings plc
Savient Pharmaceuticals Inc.
Schering AG
Schering-Plough Corp
Schwarz Pharma Ag
SciClone Pharmaceuticals Inc.
Sciele Pharma, Inc.
SCOLR Pharma Inc
Scolr Pharma Inc.
Seattle Genetics Inc.
SemBioSys Genetics Inc.
Senesco Technologies Inc.
Senetek Plc
Senomyx Inc.
Sepracor Inc.
Sepragen Corp.
Sequenom Inc.
SeraCare Life Sciences Inc.
Serono S.A.
SFBC International Inc
SGX Pharmaceuticals Inc.
Shaman Pharmaceuticals Inc.
Sheffield Pharmaceuticals Inc
Shire Pharmaceuticals Group plc
SIGA Technologies Inc
Siga Technologies Inc.
Sigma-Aldrich Corp.
Sinclair Pharma plc
Sinovac Biotech Ltd.
Sirna Therapeutics Inc.
Sirtex Medical Ltd.
SkyePharma Plc
Smith & Nephew Plc
Solbec Pharmaceuticals Ltd
Solexa Inc.
Solvay S.A.
Somaxon Pharmaceuticals Inc.
SonoSite Inc
Sontra Medical Corp.
Sontra Medical Corporation
Sonus Pharmaceuticals Inc.
Sosei Co. Ltd.
Spectral Diagnostics Inc.
Spectranetics Corporation
Spectrum Pharmaceuticals Inc.
SpectRx Inc.
Speedel
Spherix Inc.
SR Pharma plc
Stallergenes S.A.
Starpharma Holdings Ltd.
StatSure Diagnostic Systems Inc.
Stellar Pharmaceuticals Inc
Stem Cell Sciences plc
Stem Cell Therapeutics Corp.
StemCells Inc.
Stratagene Corp.
Strategic Diagnostics Inc.
Sunesis Pharmaceuticals Inc.
SuperGen Inc.
SurModics Inc.
Sygen International plc
Symbollon Pharmaceuticals Inc CL A
Symyx Technologies Inc.
Synairgen plc
Synbiotics Corp.
Syngenta AG
Synovics Pharmaceuticals Inc
SyntheMed Inc.
Synthetech Inc.
Synthetic Blood International Inc.
Syntopix Group plc
Tanox Inc.
Tapestry Pharmaceuticals Inc.
Targacept Inc.
Targeted Genetics Corp.
Taro Pharmaceutical Industries Ltd
Tecan AG
Techne Corp.
Telik Inc.
Tepnel Life Sciences plc
Tercica Inc.
Teva Pharmaceutical Industries Ltd.
The Immune Response Corp.
The Medicines Co.
The Quigley Corporation
Theragenics Corp.
Theratase plc
Theratechnologies Inc.
Theravance Inc.
Thermogenesis Corp.
Third Wave Technologies Inc.
Threshold Pharmaceuticals Inc.
ThromboGenics Ltd.
Tissera Inc.
Tissue Science Laboratories plc
Titan Pharmaceuticals Inc.
Tm Bioscience Corp.
TopoTarget A/S
Transgene S.A.
Transgenomic Inc.
Transition Therapeutics Inc.
Trimeris Inc.
Trinity Biotech plc
Trinity Medical Group USA Inc.
Tripep AB
Tripos Inc.
Tutogen Medical Inc
UCB Group
Uluru Inc.
Unigene Laboratories Inc.
United Therapeutics Corp.
United-Guardian Inc
USANA Health Sciences Inc
Valeant Pharmaceuticals
International
Valentis Inc.
Valera Pharmaceuticals Inc.
Vanda Pharmaceuticals Inc
Vanda Pharmaceuticals Inc.
Vascular Solutions Inc
Vaso Active Pharmaceuticals Inc
Vasogen Inc.
Vasomedical Inc
VASTox plc
VaxGen Inc.
Vectura Group plc
Ventana Medical Systems Inc.
Vernalis Plc ADR
Vertex Pharmaceuticals Inc.
ViaCell Inc.
Vical Inc.
Vion Pharmaceuticals Inc.
VioQuest Pharmaceuticals Inc.
Viragen Inc.
Viral Genetics Inc.
Virax Holdings Ltd.
VIRBAC CORPORATION
ViRexx Medical Corp.
ViroPharma Inc.
VitaCube Systems Holdings Inc
Vital Living Inc
Vitro Diagnostics Inc.
Vivus Inc.
Vyrex Corp.
Vyteris Holdings Inc.
Warnex Inc.
Watson Pharmaceuticals Inc.
West Pharmaceutical Services Inc.
Wex Pharmaceuticals Inc.
Whatman plc
Wockhardt Ltd.
Wyeth
Xechem International Inc.
Xenogen Corp.
Xenomics Inc.
XenoPort Inc.
Xillix Technologies Corp.
XOMA Ltd
XTL Biopharmaceuticals Ltd.
YM BioSciences Inc.
York Pharma plc
Zeltia S.A.
Zenyth Therapeutics Ltd.
Zeria Pharmaceutical Co. Ltd.
Zila Inc.
Ziopharm Oncology Inc.
ZymeTx Inc.
ZymoGenetics Inc.

### Step 2—Identification of Companies in the Cancer Subsector

Equities are then limited those that are developing at any stage, products in a specific major disease, healthcare service, and/or healthcare technology area. A Cancer company is defined as a larger company involved in the research, clinical development and/or commercialization of therapeutic agents for the treatment of a wide variety of cancers, and generally include those with substantial revenues and large, deep research and development programs. The data set generated by this rule is based upon information and categorization contained in the widely available healthcare industry specific databases MEDTRACK and BioCentury. The following is the list of companies in the Cancer sub-sector as identified by reference to those databases.

4SC AG
3M Company
Aastrom Biosciences Inc
Abbott Laboratories
Abraxis BioScience Inc.
Accentia Biopharmaceuticals Inc.
Access Pharmaceuticals Inc.
ACI Global Corp
Actelion Ltd
Active Biotech AB
Acusphere Inc
Adherex Technologies Inc.
Advanced Life Sciences Holdings Inc
Advanced Plant Pharmaceuticals Inc
Advanced Viral Research Corp
Advaxis Inc.
ADVENTRX Pharmaceuticals Inc
Aeolus Pharmaceuticals Inc
AEterna Zentaris Inc
Akzo Nobel NV
Alchemia Pty. Ltd.
Alexion Pharmaceuticals Inc
Alfacell Corp.
Alkermes Inc
Allergan Inc
Allos Therapeutics Inc.
Alpharma Inc
AlphaRx Inc
Amarin Corporation plc
Ambrilia Biopharma Inc.
Amgen Inc
Anadys Pharmaceuticals Inc.
Andrx Corp
Anesiva, Inc.
AnorMED Inc
Antigenics Inc.
Antisoma plc
Antisoma PLC
AP Pharma Inc
Aphton Corp.
Ariad Pharmaceuticals Inc.
Arius Research Inc.
Ark Therapeutics Group plc
ArQule Inc.
Array BioPharma Inc.
Arrowhead Research Corp.
Ascentia Biomedical Corp.
AstraZeneca Plc
Avalon Pharmaceuticals Inc.
AVANIR Pharmaceuticals
Avantogen Ltd.
Avantogen Oncology Inc.
Avax Technologies Inc.
AVI BioPharma Inc.
Axcan Pharma Inc
AXM Pharma Inc.
Barr Pharmaceuticals Inc.
Bavarian Nordic AS
Baxter International Inc
Bayer Ag
Bentley Pharmaceuticals Inc
BioAlliance Pharma S.A.
Biocompatibles International plc
BioCryst Pharmaceuticals Inc.
BioDelivery Sciences International Inc
Bioenvision Inc.
Biogen Idec Inc
Biomira Inc.
BioMS Medical Corp.
Bioniche Life Sciences Inc.
Bionomics Ltd.
Bionovo Inc.
Bioprogress plc
BioSphere Medical Inc.
Biosyntech Inc
Boston Life Sciences Inc
Bradmer Pharmaceuticals Inc.
Bristol-Myers Squibb Company
Callisto Pharmaceuticals Inc.
Cambridge Antibody Technology
Group plc
Can-Fite BioPharma Ltd.
Cangene Corp.
Celera Genomics Group
Celgene Corp.
Cell Genesys Inc.
Cell Therapeutics Inc.
Cellegy Pharmaceuticals Inc
CEL-SCI Corporation
Celsion Corp.
CeNeS Pharmaceuticals Plc
Cephalon Inc.
Ceragenix Phamaceuticals Inc
Cerus Corp.
Chelsea Therapeutics International
Ltd.
ChemGenex Pharmaceuticals Ltd.
Chemokine Therapeutics Corp.
Clavis Pharma AS
Cleveland BioLabs Inc.
Coley Pharmaceutical Group Inc
CollaGenex Pharmaceuticals Inc
CombinatoRx Inc.
Corautus Genetics Inc
Crucell N V
CuraGen Corp.
Curis Inc.
Cyclacel Pharmaceuticals Inc.
Cytogen Corp.
CYTOGEN Corporation
Cytogenix Inc
Cytokinetics Inc.
Cytos Biotechnology AG
CytRx Corporation
Delcath Systems Inc
Deltagen Inc
Dendreon Corp.
Diamyd Medical AB
Diomed Holdings Inc
Dnaprint Genomics Inc
DOR BioPharma Inc
Dragon Pharmaceutical Inc
DRAXIS Health Inc
DURECT Corporation
DUSA Pharmaceuticals Inc.
Dyax Corp
Dynavax Technologies Corp.
Ecopia BioSciences Inc.
EiRx Therapeutics plc
Elan Corp Plc
Eli Lilly & Co
Emisphere Technologies Inc
Encysive Pharmaceuticals Inc
Endo Pharmaceuticals Holdings Inc
EntreMed Inc.
Enzon Pharmaceuticals Inc.
EpiCept Corp
Epigenomics AG
Exact Sciences Corp.
eXegenics Inc.
Exelixis Inc.
ExonHit Therapeutics S.A.
Favrille Inc.
Flamel Technologies SA ADS
Fresenius AG
GammaCan International Inc.
Gedeon Richter Ltd
Genaera Corp.
Genaera Corporation
Genelabs Technologies Inc
GeneMax Corp.
Genentech Inc
Generex Biotechnology Corporation
Genitope Corp.
Genmab A/S
Genta Inc.
Gentium S.p.A
GenVec Inc.
Genzyme Corporation
Geron Corp.
Gilead Sciences Inc
GlaxoSmithKline plc
GlycoGenesys Inc.
GPC Biotech AG
GTC Biotherapeutics Inc
GTx Inc.
GW Pharmaceuticals PLC
Halozyme Therapeutics Inc.
Hana Biosciences Inc.
Helix BioPharma Corp.
Hemispherx Biopharma Inc
Hemosol Corp
Hollis-Eden Pharmaceuticals Inc
Human Genome Sciences Inc.
Hutchison China MediTech Ltd.
Ibex Technologies Inc.
ICOS Corp
Idera Pharmaceuticals Inc.
IDM Pharma Inc.
ImClone Systems Inc.
Immune Response Corporation
ImmunoGen Inc.
Immunomedics Inc
Immunomedics Inc.
Incyte Corp.
Inex Pharmaceuticals Corp.
Inflazyme Pharmaceuticals Ltd.
Innovata Plc
Inovio Biomedical Corp.
Insmed Incorporated
InterMune Inc
Introgen Therapeutics Inc.
Ipsen Group
Isis Pharmaceuticals Inc.
IsoRay Inc
Johnson & Johnson
Keryx Biopharmaceuticals Inc.
King Pharmaceuticals Inc
Kosan Biosciences Inc.
Kyto BioPharma Inc
Large Scale Biology Corporation
Lescarden Inc
Lexicon Genetics Incorporated
Ligand Pharmaceuticals Inc.
Liponex Inc.
Lorus Therapeutics Inc.
Lpath Inc.
MannKind Corp.
Marc Pharmaceuticals Inc.
Marshall Edwards Inc.
Matritech Inc.
Maxygen Inc.
Medarex Inc.
Medical Discoveries Inc
MediGene AG
Mudimmune Inc.
Meditech Research Ltd.
Medivation Inc
Merck & Co Inc
Metabasis Therapeutics Inc.
MethylGene Inc.
MGI Pharma Inc.
Micromet Inc.
Millennium Pharmaceuticals Inc.
Momenta Pharmaceuticals Inc.
Monogram Biosciences Inc.
MorphoSys AG
Mylan Laboratories Inc
Myriad Genetics Inc.
Nabi Biopharmaceuticals
Nastech Pharmaceutical Co Inc
Nektar Therapeutics
NeoPharm Inc.
Neurobiological Technologies Inc
Neurocrine Biosciences Inc
NexMed Inc
Nitromed Inc
North American Scientific Inc.
Northwest Biotherapeutics Inc.
Norwood Immunology Ltd.
Novacea Inc.
Novadel Pharma Inc
Novartis AG
Novavax Inc
Novelos Therapeutics Inc.
Novogen Ltd.
Novo-Nordisk A
NuOncology Labs Inc.
Nuvelo Inc.
Nventa Biopharmaceuticals Corp
Oncolytics Biotech Inc.
Onyx Pharmaceuticals Inc.
OSI Pharmaceuticals Inc.
Oxford BioMedica plc
OXiGENE INC
Palatin Technologies Inc
Paligent Inc
Par Pharmaceutical Companies Inc
PDL BioPharma Inc.
Peplin Ltd.
Peregrine Pharmaceuticals Inc.
Pfizer Inc
Pharmacopeia Drug Discovery Inc
Pharmacyclics Inc.
PharmaGap Inc.
Pharmexa A/S
Pharmion Corp.
PhotoCure ASA
Phylogica Ltd
Phynova Group plc
Phytopharm PLC
Point Therapeutics Inc.
Poniard Pharmaceuticals Inc.
Praecis Pharmaceuticals
Incorporated
Prescient NeuroPharma Inc.
Prima Biomed Ltd.
Progen Industries Ltd.
Progenics Pharmaceuticals Inc.
ProMetic Life Sciences Inc.
Pro-Pharmaceuticals Inc.
Protherics PLC
Protox Therapeutics Inc.
Provectus Pharmaceuticals Inc.
QLT Inc.
Quest PharmaTech Inc.
Questcor Pharmaceuticals Inc
Quigley Corp.
Raptor Pharmaceutical Inc.
Regeneron Pharmaceuticals Inc.
Repros Therapeutics Inc
Resverlogix Corp.
Rexahn Pharmaceuticals Inc.
Rigel Pharmaceuticals Inc.
Roche Holdings Ltd
Salix Pharmaceuticals Ltd
Samaritan Pharmaceuticals Inc.
Sangamo BioSciences Inc
Sanofi-Aventis
Savient Pharmaceuticals Inc
Schering-Plough Corp
Schwarz Pharma Ag
SciClone Pharmaceuticals Inc.
Seattle Genetics Inc.
Senesco Technologies Inc.
Serono S.A
SGX Pharmaceuticals Inc.
Shire plc
Sirna Therapeutics Inc
Sirtex Medical Ltd.
SkyePharma Plc
Solbec Pharmaceuticals Ltd
Sonus Pharmaceuticals Inc.
Spectrum Pharmaceuticals Inc.
SR Pharma plc
Sunesis Pharmaceuticals Inc.
SuperGen Inc.
Tanox Inc
Tanox Inc.
Tapestry Pharmaceuticals Inc.
Targeted Genetics Corp
Telik Inc.
Tercica Inc
Teva Pharmaceutical Industries Ltd
Theragenics Corp.
Threshold Pharmaceuticals Inc.
Titan Pharmaceuticals Inc
TopoTarget A/S
Transgene S.A.
Unigene Laboratories Inc
United Therapeutics Corp.
Valeant Pharmaceuticals
International
Valentis Inc
Valera Pharmaceuticals Inc.
VaxGen Inc
Vernalis Plc ADR
Vertex Pharmaceuticals Inc.
ViaCell Inc
Vical Inc.
Vion Pharmaceuticals Inc.
VioQuest Pharmaceuticals Inc.
Viragen Inc.
Virax Holdings Ltd.
ViRexx Medical Corp.
Watson Pharmaceuticals Inc
Wyeth
Xechem International Inc.
Xenoport Inc
XOMA Ltd
YM BioSciences Inc.
Zeltia S.A.
Zenyth Therapeutics Ltd.
Ziopharm Oncology Inc.
ZymoGenetics Inc.

### Step 3—Identification of Companies in the Cancer Subsector Within a Market Capitalization Range

Equities are then limited to those with a minimum market capitalization of $100 million and maximum market capitalization of $15 billion. The data set generated by this rule is based upon information and categorization contained in the widely available healthcare industry specific databases MEDTRACK and BioCentury. The following is the list of companies in the Cancer subsector with the prescribed market capitalization.

Aastrom Biosciences Inc
Abraxis BioScience Inc
Accentia Biopharmaceuticals Inc.
ACI Global Corp
Actelion Ltd
Active Biotech AB
ADVENTRX Pharmaceuticals Inc
Adventrx Pharmaceuticals Inc.
AEterna Zentaris Inc
Alchemia Pty. Ltd.
Alexion Pharmaceuticals Inc
Alkermes Inc
Allos Therapeutics Inc.
Alpharma Inc
Amarin Corporation plc
Anadys Pharmaceuticals Inc.
Andrx Corp
Anesiva, Inc.
AnorMED Inc
Ariad Pharmaceuticals Inc.
Ark Therapeutics Group plc
ArQule Inc.
Array BioPharma Inc.
AVANIR Pharmaceuticals
AVI BioPharma Inc.
Axcan Pharma Inc
Barr Pharmaceuticals Inc
Bavarian Nordic AS
Bentley Pharmaceuticals Inc
BioAlliance Pharma S.A.
Biocompatibles International plc
BioCryst Pharmaceuticals Inc.
Bioenvision Inc.
Biogen Idec Inc
BioMS Medical Corp.
BioSphere Medical Inc.
Cambridge Antibody Technology
Group plc
Cangene Corp.
Celera Genomics Group
Celgene Corp.
Cell Genesys Inc.
Cell Therapeutics Inc.
Cephalon Inc.
Cerus Corp.
Cerus Corporation
Clavis Pharma AS
Coley Pharmaceutical Group Inc
CollaGenex Pharmaceuticals Inc
CombinatoRx Inc.
Crucell N V
CuraGen Corp.
Cyclacel Pharmaceuticals Inc.
Cytogenix Inc
Cytokinetics Inc.
Cytos Biotechnology AG
Delcath Systems Inc
Dendreon Corp.
DRAXIS Health Inc
DURECT Corporation
Dyax Corp
Dynavax Technologies Corp.
Elan Corp Plc
Encysive Pharmaceuticals Inc
Endo Pharmaceuticals Holdings Inc
EntreMed Inc.
Enzon Pharmaceuticals Inc.
Exelixis Inc.
ExonHit Therapeutics S.A.
Favrille Inc.
Flamel Technologies SA ADS
Gedeon Richter Ltd
Generex Biotechnology Corporation
Genitope Corp.
Genmab A/S
Genta Inc.
Genta Incorporated
Gentium S.p.A
Geron Corp.
Geron Corporation
GPC Biotech AG
GTx Inc.
GW Pharmaceuticals PLC
Halozyme Therapeutics Inc.
Hana Biosciences Inc.
Hemispherx Biopharma Inc
Hollis-Eden Pharmaceuticals Inc
Human Genome Sciences Inc.
Hutchison China MediTech Ltd.
ICOS Corp
ImClone Systems Inc.
ImmunoGen Inc.
Immunomedics Inc.
Incyte Corp.
Incyte Corporation
Innovata Plc
Insmed Incorporated
InterMune Inc
Introgen Therapeutics Inc.
Ipsen Group
Isis Pharmaceuticals Inc.
Keryx Biopharmaceuticals Inc.
King Pharmaceuticals Inc
Kosan Biosciences Inc.
Lexicon Genetics Incorporated
Ligand Pharmaceuticals Inc.
MannKind Corp.
Marshall Edwards Inc.
Maxygen Inc.
Medarex Inc.
MediGene AG
MedImmune Inc.
Metabasis Therapeutics Inc.
MGI Pharma Inc.
Micromet Inc.
Millennium Pharmaceuticals Inc.
Momenta Pharmaceuticals Inc.
Monogram Biosciences Inc.
MorphoSys AG
Mylan Laboratories Inc
Myriad Genetics Inc.
Nabi Biopharmaceuticals
Nastech Pharmaceutical Co Inc
Nektar Therapeutics
NeoPharm Inc.
Neurocrine Biosciences Inc
Nitromed Inc
Novacea Inc.
Novavax Inc
Novogen Ltd.
Nuvelo Inc.
Onyx Pharmaceuticals Inc.
OSI Pharmaceuticals Inc.
Oxford BioMedica plc
Palatin Technologies Inc
Par Pharmaceutical Companies Inc
PDL BioPharma Inc.
Peplin Ltd.
Peregrine Pharmaceuticals Inc.
Pharmexa A/S
Pharmion Corp.
PhotoCure ASA
Poniard Pharmaceuticals Inc.
Progenics Pharmaceuticals Inc.
Protherics PLC
QLT Inc.
Regeneron Pharmaceuticals Inc.
Resverlogix Corp.
Rigel Pharmaceuticals Inc.
Salix Pharmaceuticals Ltd
Sangamo BioSciences Inc
Savient Pharmaceuticals Inc
Schwarz Pharma Ag
Seattle Genetics Inc.
Serono S.A
Shire plc
Sirna Therapeutics Inc
SkyePharma Plc
Sonus Pharmaceuticals Inc.
Sunesis Pharmaceuticals Inc.
SuperGen Inc.
Tanox Inc.
Telik Inc.
Tercica Inc
Threshold Pharmaceuticals Inc.
TopoTarget A/S
Transgene S.A.
Unigene Laboratories Inc
United Therapeutics Corp.
Valeant Pharmaceuticals
International
Valera Pharmaceuticals Inc.
Vernalis Plc ADR
Vertex Pharmaceuticals Inc.
ViaCell Inc
Vical Inc.
Watson Pharmaceuticals Inc
Xenoport Inc
XOMA Ltd
YM BioSciences Inc.
ZymoGenetics Inc.

### Step 4—Limiting the Identified Companies in the T-Cancer Subsector to Those with a Focus in the T-Cancer Subsector

The list of equities is further focused to those companies with an operational focus in the chosen disease category by application of five Boolean rules. The equity complies with this rule if one or more of the following are true:

(1) The equity markets no less than 10 products within the given disease category and has at least one active clinical trial within the category. Products in the regulatory phase do not count qualify towards the active clinical trial stipulation of this rule.

(2) The equity markets no less than 20 products within a given disease category.

(3) As shown in the formula below, the ratio of products in all phases of clinical trials, including pre-approved and NDA filings, in a given disease category over the total number of products the company has on the market, in clinical trials, and all stages of regulatory filing in the given disease category is greater than 35%.

(Products in trial)/(All products on the market, in clinical trials, and in regulatory filing)>35%

(4) The equity has no less than 5 products in clinical trials within the given disease category.

(5) The percentage of an equity's total products the company markets or is developing within the given disease category is greater than 50% of all products the company markets or is developing.

(Products marketed or in development within the disease category)/(All products the company markets or is developing)>50%

The equities meeting the criteria of the above rule set are then sorted by market capitalization in descending order from largest to smallest in order to apply the final rule.

### The following is the list of companies complying with each of the focus rules.

Focus Rule 1

Abraxis BioScience Inc

Focus Rule 2

Abraxis BioScience Inc

Focus Rule 3

| | | |
|---|---|---|
| Biogen Idec Inc | Onyx Pharmaceuticals Inc | Seattle Genetics Inc |
| Serono S.A | Axcan Pharma Inc | SuperGen Inc |
| MedImmune Inc | Pharmion Corp | Bioenvision Inc |
| Cephalon Inc | Keryx Biopharmaceuticals Inc | Genta Incorporated |
| Vertex Pharmaceuticals Inc | Isis Pharmaceuticals Inc | Hana Biosciences Inc |
| Ipsen | GPC Biotech AG | ArQule Inc |
| Abraxis BioScience Inc | Geron Corporation | CuraGen Corp |
| Millennium Pharmaceuticals Inc | BioCryst Pharmaceuticals Inc | XOMA Ltd |
| Imclone Systems Inc | Enzon Pharmaceuticals Inc | Sonus Pharmaceuticals Inc |
| PDL BioPharma Inc | Dendreon Corp | AVI BioPharma Inc |
| OSI Pharmaceuticals Inc | Array BioPharma Inc | Introgen Therapeutics Inc |
| United Therapeutics Corporation | AEterna Zentaris Inc | Sunesis Pharmaceuticals Inc |
| Human Genome Sciences Inc | Peregrine Pharmaceuticals Inc | Cell Therapeutics Inc |
| Cambridge Antibody Technology | GTX INC | Vical Inc |
| Group plc | | |
| Medarex Inc | Ariad Pharmaceuticals Inc | ImmunoGen Inc |
| MGI Pharma Inc | Cell Genesys Inc | Favrille Inc |
| ZymoGenetics Inc | Innovata Plc | NeoPharm Inc |
| Myriad Genetics Inc | Cytokinetics Inc | Kosan Biosciences Incorporated |
| Telik Inc | Allos Therapeutics Inc | Insmed Incorporated |
| Exelixis Inc | ADVENTRX Pharmaceuticals Inc | EntreMed Inc |
| Regeneron Pharmaceuticals Inc | Genitope Corp | Delcath Systems Inc |
| Ligand Pharmaceuticals Inc | Novacea Inc | Immunomedics Inc |

Focus Rule 4

| | | |
|---|---|---|
| Biogen Idec Inc | Ligand Pharmaceuticals Inc | SuperGen Inc |
| Serono S.A | Onyx Pharmaceuticals Inc | Bioenvision Inc |
| MedImmune Inc | Pharmion Corp | Genta Incorporated |
| Cephalon Inc | Keryx Biopharmaceuticals Inc | Hana Biosciences Inc |
| Ipsen | Isis Pharmaceuticals Inc | ArQule Inc |
| Abraxis BioScience Inc | GPC Biotech AG | CuraGen Corp |
| Millennium Pharmaceuticals Inc | BioCryst Pharmaceuticals Inc | AVI BioPharma Inc |
| Imclone Systems Inc | Dendreon Corp | Introgen Therapeutics Inc |
| OSI Pharmaceuticals Inc | Coley Pharmaceutical Group Inc | Sunesis Pharmaceuticals Inc |
| Human Genome Sciences Inc | AEterna Zentaris Inc | Cell Therapeutics Inc |
| Cambridge Antibody Technology | Peregrine Pharmaceuticals Inc | Vical Inc |
| Group plc | | |
| Medarex Inc | Ariad Pharmaceuticals Inc | ImmunoGen Inc |
| MGI Pharma Inc | Cell Genesys Inc | NeoPharm Inc |
| ZymoGenetics Inc | Cytokinetics Inc | Kosan Biosciences Incorporated |
| Telik Inc | Allos Therapeutics Inc | EntreMed Inc |
| Exelixis Inc | Seattle Genetics Inc | |

Focus Rule 5

| | | |
|---|---|---|
| Millennium Pharmaceuticals Inc | Coley Pharmaceutical Group Inc | Bioenvision Inc |
| Imclone Systems Inc | AEterna Zentaris Inc | Genta Incorporated |
| OSI Pharmaceuticals Inc | Peregrine Pharmaceuticals Inc | Hana Biosciences Inc |
| Medarex Inc | GTX INC | CuraGen Corp |
| MGI Pharma Inc | Ariad Pharmaceuticals Inc | Introgen Therapeutics Inc |
| Telik Inc | Cytokinetics Inc | Sunesis Pharmaceuticals Inc |
| Exelixis Inc | Allos Therapeutics Inc | Favrille Inc |
| Onyx Pharmaceuticals Inc | Genitope Corp | NeoPharm Inc |
| Pharmion Corp | Novacea Inc | Kosan Biosciences Incorporated |
| Keryx Biopharmaceuticals Inc | Seattle Genetics Inc | Insmed Incorporated |
| GPC Biotech AG | SuperGen Inc | EntreMed Inc |
| BioCryst Pharmaceuticals Inc | Tercica Inc | |

The following is the combined list of all companies complying at least one of the focus rules.

| | | |
|---|---|---|
| Biogen Idec Inc | Axcan Pharma Inc | Seattle Genetics Inc |
| Serono S.A | Progenics Pharmaceuticals Inc | SuperGen Inc |
| MedImmune Inc | Pharmion Corp | Tercica Inc |
| Cephalon Inc | Keryx Biopharmaceuticals Inc | Bioenvision Inc |
| Vertex Pharmaceuticals Inc | Isis Pharmaceuticals Inc | Genta Incorporated |
| Ipsen | GPC Biotech AG | Hana Biosciences Inc |
| Abraxis BioScience Inc | Geron Corporation | ArQule Inc |
| Millennium Pharmaceuticals Inc | BioCryst Pharmaceuticals Inc | CuraGen Corp |
| Imclone Systems Inc | Enzon Pharmaceuticals Inc | XOMA Ltd |
| PDL BioPharma Inc | Dendreon Corp | Sonus Pharmaceuticals Inc |
| OSI Pharmaceuticals Inc | Array BioPharma Inc | AVI BioPharma Inc |
| United Therapeutics Corporation | Coley Pharmaceutical Group Inc | Introgen Therapeutics Inc |
| Human Genome Sciences Inc | AEterna Zentaris Inc | Sunesis Pharmaceuticals Inc |
| Cambridge Antibody Technology | Peregrine Pharmaceuticals Inc | Cell Therapeutics Inc |
| Group plc | | |
| Medarex Inc | GTX INC | Vical Inc |
| MGI Pharma Inc | Ariad Pharmaceuticals Inc | ImmunoGen Inc |
| ZymoGenetics Inc | Cell Genesys Inc | Favrille Inc |
| Myriad Genetics Inc | Innovata Plc | NeoPharm Inc |
| Telik Inc | Cytokinetics Inc | Kosan Biosciences Incorporated |
| Exelixis Inc | Allos Therapeutics Inc | Insmed Incorporated |
| Regeneron Pharmaceuticals Inc | ADVENTRX Pharmaceuticals Inc | EntreMed Inc |
| Ligand Pharmaceuticals Inc | Genitope Corp | Delcath Systems Inc |
| Onyx Pharmaceuticals Inc | Novacea Inc | Immunomedics Inc |

### Step 5—Final Identification of Equities in the Subsector

Companies are ranked by market capitalization. Those companies that have announced pending acquisition are eliminated from the list of equities and finally the top 22 equities are chosen to comprise the index. The index is then given a weighted ratio to compose an ETF.

| Market Cap Rank | Equity | Comments |
|---|---|---|
| 1 | Biogen Idec Inc | Included in the Index |
| 2 | Serono S.A | Included in the Index |
| 3 | MedImmune Inc | Included in the Index |
| 4 | Cephalon Inc | Included in the Index |
| 5 | Vertex Pharmaceuticals Inc | Included in the Index |
| 6 | Ipsen | Included in the Index |
| 7 | Abraxis BioScience Inc | Included in the Index |
| 8 | Millennium Pharmaceuticals Inc | Included in the Index |
| 9 | Imclone Systems Inc | Included in the Index |
| 10 | PDL BioPharma Inc | Included in the Index |
| 11 | OSI Pharmaceuticals Inc | Included in the Index |
| 12 | United Therapeutics Corporation | Included in the Index |
| 13 | Human Genome Sciences Inc | Included in the Index |
| 14 | [symbol] | Excluded from Index because of |
| | [symbol] | pending acquisition |
| 15 | Medarex Inc | Included in the Index |
| 16 | MGI Pharma Inc | Included in the Index |
| 17 | ZymoGenetics Inc | Included in the Index |
| 18 | Myriad Genetics Inc | Included in the Index |
| 19 | Telik Inc | Included in the Index |
| 20 | Exelixis Inc | Included in the Index |
| 21 | Regeneron Pharmaceuticals Inc | Included in the Index |
| 22 | Ligand Pharmaceuticals Inc | Included in the Index |
| 23 | Onyx Pharmaceuticals Inc | Included in the Index |
| 24 | Axcan Pharma Inc | Not included in the Index |
| 25 | Progenics Pharmaceuticals Inc | Not included in the Index |
| 26 | Pharmion Corp | Not included in the Index |
| 27 | Keryx Biopharmaceuticals Inc | Not included in the Index |
| 28 | Isis Pharmaceuticals Inc | Not included in the Index |
| 29 | GPC Biotech AG | Not included in the Index |
| 30 | Geron Corporation | Not included in the Index |
| 31 | BioCryst Pharmaceuticals Inc | Not included in the Index |
| 32 | Enzon Pharmaceuticals Inc | Not included in the Index |
| 33 | Dendreon Corp | Not included in the Index |
| 34 | Array BioPharma Inc | Not included in the Index |
| 35 | Coley Pharmaceutical Group Inc | Not included in the Index |
| 36 | AEterna Zentaris Inc | Not included in the Index |
| 37 | Peregrine Pharmaceuticals Inc | Not included in the Index |
| 38 | GTX INC | Not included in the Index |
| 39 | Ariad Pharmaceuticals Inc | Not included in the Index |
| 40 | Cell Genesys Inc | Not included in the Index |
| 41 | Innovata Plc | Not included in the Index |
| 42 | Cytokinetics Inc | Not included in the Index |
| 43 | Allos Therapeutics Inc | Not included in the Index |
| 44 | ADVENTRX Pharmaceuticals Inc | Not included in the Index |
| 45 | Genitope Corp | Not included in the Index |
| 46 | Novacea Inc | Not included in the Index |
| 47 | Seattle Genetics Inc | Not included in the Index |
| 48 | SuperGen Inc | Not included in the Index |
| 49 | Tercica Inc | Not included in the Index |
| 50 | Bioenvision Inc | Not included in the Index |
| 51 | Genta Incorporated | Not included in the Index |
| 52 | Hana Biosciences Inc | Not included in the Index |
| 53 | ArQule Inc | Not included in the Index |
| 54 | CuraGen Corp | Not included in the Index |
| 55 | XOMA Ltd | Not included in the Index |
| 56 | Sonus Pharmaceuticals Inc | Not included in the Index |
| 57 | AVI BioPharma Inc | Not included in the Index |
| 58 | Introgen Therapeutics Inc | Not included in the Index |
| 59 | Sunesis Pharmaceuticals Inc | Not included in the Index |
| 60 | Cell Therapeutics Inc | Not included in the Index |
| 61 | Vical Inc | Not included in the Index |
| 62 | ImmunoGen Inc | Not included in the Index |
| 63 | Favrille Inc | Not included in the Index |
| 64 | NeoPharm Inc | Not included in the Index |
| 65 | Kosan Biosciences Incorporated | Not included in the Index |
| 66 | Insmed Incorporated | Not included in the Index |
| 67 | EntreMed Inc | Not included in the Index |
| 68 | Delcath Systems Inc | Not included in the Index |
| 69 | Immunomedics Inc | Not included in the Index |

The examples and discussion above are put forth so as to provide those of ordinary skill in the art with a complete disclosure and description of how to make and use various embodiments of the present invention, and are not intended to limit the scope of what the inventors regard as their invention nor are they intended to represent that the examples above are all or the only examples performed.

What is claimed is:

1. A financial instrument comprising securities of companies in a subsector of the economy wherein the securities are selected using selection criteria.

2. The financial instrument according to claim 1 wherein the financial instrument is selected from the group consisting of: a mutual fund, an open end fund, a closed end fund (including a unit investment trust), a future, an option and an exchange traded fund.

3. The financial instrument according to claim 1 wherein the financial instrument is linked to an index.

4. The financial instrument according to claim 1 wherein the subsector of the economy is defined based on development of individual technologies.

5. The financial instrument according to claim 5 wherein the individual technology is selected from the group consisting of diagnostics, cardio devices, orthopedic repair, enabling technologies, European drugs, European medial products and devices and Asian healthcare.

6. The financial instrument according to claim 1 wherein the subsector of the economy is defined based on disease application.

7. The financial instrument according to claim 7 wherein the disease application is selected from the group consisting of respiratory or pulmonary diseases, cancer, derma or wound care, ophthalmology, infectious diseases, metabolic or endocrine disorders, autoimmune disorders, CNS disorders, cardiology, genitourinary, gastrointestinal, sexual dysfunction, reproductive health or inflammatory disorders.

8. The financial instrument according to claim 1 wherein the securities of companies in a subsector of the economy are identified by reference to a database.

9. The financial instrument according to claim 8 wherein the database is selected from the group consisting of BioCentury's database, MedTrack's database, or MedTech Insight's database.

10. The financial instrument according to claim 1 wherein the selection criteria comprises a nexus to the subsector of the economy.

11. The financial instrument according to claim 10 wherein the nexus is selected from the group consisting of:
a. the sales of products in the subsector of the economy;
b. the running of clinical trials in the subsector of the economy;
c. research emphasis in the subsector of the economy; and
d. business focus of the security's issuer to the subsector of the economy.

12. The financial instrument according to claim 10 wherein the nexus is a ratio between the security issuer's research emphasis in the subsector of the economy and all products marketed by the issuer.

13. The financial instrument according to claim 11 wherein the indicator of the security issuer's research emphasis is the number of clinical trials in the subsector of the economy.

14. The financial instrument according to claim 11 wherein the business focus of the security's issuer to the subsector of the economy is shown by a ratio between the sum of the issuer's number of products and an indicator of the issuer's research emphasis in a particular subsector, and all of the issuer's products.

15. The financial instrument according to claim 14 wherein the indicator of the issuer's research emphasis is the number of the issuer's clinical trials in the subsector.

16. The financial instrument according to claim 1 wherein the selection criteria comprises the issuers of the financial instrument's securities having a market capitalization between a predetermined range.

17. The financial instrument according to claim 1 wherein the securities are listed on a U.S. or foreign exchange.

18. The financial instrument according to claim 1 wherein the securities have depository receipts in either American (ADR) or global (GDR) form listed on a U.S. or Canadian exchange.

19. The financial instrument according to claim 1 wherein the selection criteria comprises the securities' issuers having less than a predetermined amount of annual revenues from product sales, but having at least the equivalent of one year's operating costs in cash on its balance sheets.

20. The financial instrument according to claim 1 wherein the selection criteria comprises the location of the security issuer's headquarters.

21. The financial instrument according to claim 1 wherein the financial instrument is a composite financial instrument

22. A method of creating and/or managing a financial instrument comprising securities of companies in a subsector of the economy, the method comprising the steps of (a) identifying securities of companies in a sector of the economy; (b) limiting the identified securities to those for companies in a subsector of the economy; (c) applying focus rules to limit the identified securities to those for companies who are focused in the subsector of the economy; and (d) limiting the identified securities to those that satisfy objective criteria.

23. The method according to claim 22 wherein the sector is healthcare.

24. The method according to claim 22 wherein the subsector of the economy is defined by development of individual technologies.

25. The method according to claim 24 wherein the individual technology is selected from the group consisting of diagnostics, cardio devices, orthopedic repair, enabling technologies, European drugs, European medical products and devices and Asian healthcare.

26. The method according to claim 22 wherein the subsector of the economy is defined by disease application.

27. The method according to claim 26 wherein the disease application is selected from the group consisting of respiratory or pulmonary diseases, cancer, derma or wound care, ophthalmology, infectious diseases, metabolic or endocrine disorders, autoimmune disorders, CNS disorders, cardiology, genitourinary, gastrointestinal, sexual dysfunction, reproductive health or inflammatory disorders.

28. The method according to claim 22 wherein the securities of companies in a subsector of the economy are identified by reference to a database.

29. The method according to claim 28 wherein the database is selected from the group consisting of BioCentury's database, MedTrack's database, or MedTech Insight's database.

30. The method according to claim 22 wherein the issuers of the financial instrument's securities have a nexus to the subsector of the economy.

31. The method according to claim 30 wherein the nexus is selected from the group consisting of (i) the sales of products in the subsector of the economy, (ii) the running of clinical trials in the subsector of the economy, (iii) research emphasis in the subsector of the economy, and (iv) a business focus of the security's issuer to the subsector of the economy.

32. The method according to claim 30 wherein the nexus is a ratio between the security issuer's research emphasis in the subsector of the economy and all products marketed by the issuer.

33. The method according to claim 32 wherein the indicator of the security issuer's research emphasis is the number of clinical trials in the subsector of the economy.

34. The method according to claim 31 wherein the business focus of the security's issuer to subsector of the economy is shown by a ratio between the sum of the issuer's number of products and an indicator of the issuer's research emphasis in a particular subsector, and all of the issuer's products.

35. The method according to claim 34 wherein the indicator of the issuer's research emphasis is the number of the issuer's clinical trials in the subsector.

36. The method according to claim 22 wherein the issuers of the financial instrument's securities have a market capitalization between a predetermined range.

37. The method according to claim 22 wherein the securities are listed on a U.S. or foreign exchange or have depository receipts in either American (ADR) or global (GDR) form listed on a U.S. or Canadian exchange.

38. The method according to claim 22 wherein the securities' issuers, which have less than a predetermined amount of annual revenues from product sales, have at least the equivalent of one year's operating costs in cash on its balance sheets.

39. The method according to claim 22 wherein the criteria comprises the location of the security issuer's headquarters.

40. The method according to claim 22 wherein the financial instrument is a composite financial instrument.

41. An index comprising securities of companies in a subsector of the economy wherein the securities are selected using selection criteria.

42. The index according to claim 41 wherein the index is linked to a financial instrument.

43. The index according to claim 42 wherein the financial instrument is selected from the group consisting of a mutual fund, an open end fund, a closed end fund a unit investment trust, a future an option and an exchange traded fund.

44. The index according to claim 41 wherein the subsector of the economy is defined based on development of individual technologies or disease application.

45. The index according to claim 44 wherein the individual technology is selected from the group consisting of diagnostics, cardio devices, orthopedic repair, enabling technologies, European drugs, European medical products and devices and Asian healthcare.

46. The index according to claim 44 wherein the disease application is selected from the group consisting of respiratory or pulmonary diseases, cancer, derma or wound care, ophthalmology, infectious diseases, metabolic or endocrine disorders, autoimmune disorders, CNS disorders, cardiology, genitourinary, gastrointestinal, sexual dysfunction, reproductive health or inflammatory disorders.

47. The index according to claim 41 wherein the securities of companies in a subsector of the economy are identified by reference to a database.

48. The index according to claim 47 wherein the database is selected from the group consisting of BioCentury's database, MedTrack's database, or MedTech Insight's database.

49. The index according to claim 41 wherein the issuers of the index's securities have a nexus to the subsector of the economy.

50. The index according to claim 49 wherein the commercial nexus is selected from the group consisting of (i) the sales of products in the subsector of the economy, (ii) the running of clinical trials in the subsector of the economy, (iii) research emphasis in the subsector of the economy, and (iv) a business focus of the security's issuer to the subsector of the economy.

51. The index according to claim 49 wherein the nexus is a ratio between the security issuer's research emphasis in the subsector of the economy and all products marketed by the issuer.

52. The index according to claim 51 wherein the indicator of the security issuer's research emphasis is the number of clinical trials in the subsector of the economy.

53. The index according to claim 51 wherein the business focus of the security's issuer to subsector of the economy is shown by a ratio between the sum of the issuer's number of products and an indicator of the issuer's research emphasis in a particular subsector, and all of the issuer's products.

54. The index according to claim 50 wherein the indicator of the issuer's research emphasis is the number of the issuer's clinical trials in the subsector.

55. The index according to claim 41 wherein the issuers of the financial instrument's securities have a market capitalization between a predetermined range.

56. The index according to claim 41 wherein the securities are listed on a U.S. or foreign exchange, or have depository receipts in either American (ADR) or global (GDR) form listed on a U.S. or foreign exchange.

57. The index according to claim 41 wherein the securities' issuers, which have less than a predetermined amount of annual revenues from product sales, have at least the equivalent of one year's operating costs in cash on its balance sheets.

58. The index according to claim 41 wherein the index is a composite index.
